(19) United States
(12) Patent Application Publication
(10) Pub. No.: US 2022/0178630 A1
(43) Pub. Date: Jun. 9, 2022

(54) HEAT EXCHANGE ELEMENT AND HEAT EXCHANGE-TYPE VENTILATION DEVICE USING SAME

(71) Applicant: Panasonic Intellectual Property Management Co., Ltd., Osaka (KR)

(72) Inventors: Eisaku KUMAZAWA, Aichi (JP); Yohsuke HAMADA, Aichi (JP); Motoki HATA, Aichi (JP); Masato HONDA, Aichi (JP); Shotaro YAMAGUCHI, Aichi (JP)

(21) Appl. No.: 17/426,090

(22) PCT Filed: Aug. 21, 2019
(86) PCT No.: PCT/JP2019/032520

§ 371 Date: Jul. 27, 2021

(30) Foreign Application Priority Data
Feb. 27, 2019 (JP) 2019-033630
Apr. 25, 2019 (JP) 2019-083529
Apr. 25, 2019 (JP) 2019-083530

(51) Int. Cl. F28F 21/00; F24F 12/00; F28F 3/08

(52) U.S. Cl. CPC F28F 21/003; F28F 2275/02; F28F 3/08; F24F 12/006

(57) ABSTRACT

Heat exchange element is heat exchange element where heat exchange element pieces each of which includes heat transfer plate with heat conductivity and a plurality of ribs provided on one surface of heat transfer plate are laminated to alternately form exhaust air passage and supply air passage, and exhaust air flow flowing in exhaust air passage and supply air flow flowing in supply air passage exchange heat via heat transfer plate, heat transfer plate and rib are fixed to each other by an adhesive member, rib is formed of a plurality of fiber members with heat meltability and hygroscopicity, and rib has a fiber melting layer that is formed by melting and fixing the plurality of fiber members on the surface of rib.

### TECHNICAL FIELD

The present disclosure relates to a heat exchange element that is used in a cold region or the like and exchanges heat between an exhaust air flow for exhausting indoor air to the outdoors and a supply air flow for supplying outdoor air to the indoors, and a heat exchange-type ventilation device using the heat exchange element.

### BACKGROUND ART

Conventionally, the following has been known as a structure of a heat exchange element that is used in this type of heat exchange-type ventilation device in order to secure reliability as a result of an improvement in sealability (a sealing function to prevent air flowing in an air flow path from leaking to the outside) (see, for example, PTL 1).

FIG. 8 is an exploded perspective view illustrating a structure of conventional heat exchange element 11.

As illustrated in FIG. 8, heat exchange element 11 is configured by laminating a large number of heat exchange element pieces 12 including functional papers 13 with heat conductivity and ribs 14. On one surface of functional paper 13, a plurality of ribs 14 composed of paper string 15 and hot melt resin 16 that adheres paper string 15 to functional paper 13 are provided in parallel at predetermined intervals. This rib 14 creates a gap between a pair of functional papers 13 laminated adjacent to each other, thereby forming air flow path 17. Heat exchange element 11 is configured such that a plurality of gaps are stacked and blowing directions of respective air flow paths 17 in adjacent gaps are orthogonal to each other. As a result, in air flow path 17, the supply air flow and the exhaust air flow are alternately ventilated every functional paper 13, and heat is exchanged between the supply air flow and the exhaust air flow.

### CITATION LIST

### Patent Literature

PTL 1: Unexamined Japanese Patent Publication No. H11-248390

### SUMMARY OF THE INVENTION

As described above, conventional heat exchange element 11 has a configuration in which rib 14 is formed by covering paper string 15 with a substantially circular cross-section with hot melt resin 16, and rib 14 formed is adhered to functional paper 13 with hot melt resin 16, so that the space between functional papers 13 is maintained. However, since paper string 15 has low rigidity, paper string 15 is easy to bend due to an external force or the like. Furthermore, since functional paper 13 and paper string 15 expand when absorbing moisture in the air, the adhesive surface between functional paper 13 and rib 14 is easily peeled off. Since these phenomena make it impossible to maintain the shape of an air passage (for example, air flow path 17), the conventional heat exchange element has a problem that the air flowing in the heat exchange element is uneven and the heat exchange efficiency decreases.

Therefore, an object of the present disclosure is to provide a heat exchange element capable of suppressing a decrease in heat exchange efficiency due to a change in the shape of an air passage, and a heat exchange-type ventilation device using the heat exchange element.

In order to achieve this object, the heat exchange element according to the present disclosure includes unit constituent members each of which includes a partition member with heat conductivity and a plurality of spacing members provided on one surface of the partition member, the unit constituent members being laminated to alternately form an exhaust air passage and a supply air passage, wherein an exhaust air flow flowing in the exhaust air passage and a supply air flow flowing in the supply air passage exchange heat via the partition member. The partition member and the spacing member are fixed to each other by an adhesive member. The each of the plurality of spacing members includes a plurality of fiber members with heat meltability and hygroscopicity. The each of the plurality of spacing members has a fiber melting layer formed by melting and fixing the plurality of fiber members on a surface of the each of the plurality of spacing members.

According to the present disclosure, it is possible to provide a heat exchange element capable of suppressing a decrease in heat exchange efficiency due to a change in the shape of an air passage such as an exhaust air passage or a supply air passage, and a heat exchange-type ventilation device using the heat exchange element.

### BRIEF DESCRIPTION OF DRAWINGS

FIG. 1 is a schematic view illustrating an installation state of a heat exchange-type ventilation device according to a first exemplary embodiment of the present disclosure in a house.

FIG. 2 is a schematic view illustrating a structure of the heat exchange-type ventilation device according to the first exemplary embodiment.

FIG. 3 is an exploded perspective view illustrating a structure of a heat exchange element according to the first exemplary embodiment.

FIG. 4 is a partial cross-sectional view illustrating a structure of a rib according to the first exemplary embodiment.

FIG. 5 is a view for explaining a method of manufacturing the rib according to the first exemplary embodiment.

FIG. 6 is a view for explaining a method of manufacturing the heat exchange element according to the first exemplary embodiment.

FIG. 7 is a partial cross-sectional view illustrating a structure of a rib according to a modification.

FIG. 8 is an exploded perspective view illustrating a structure of a conventional heat exchange element.

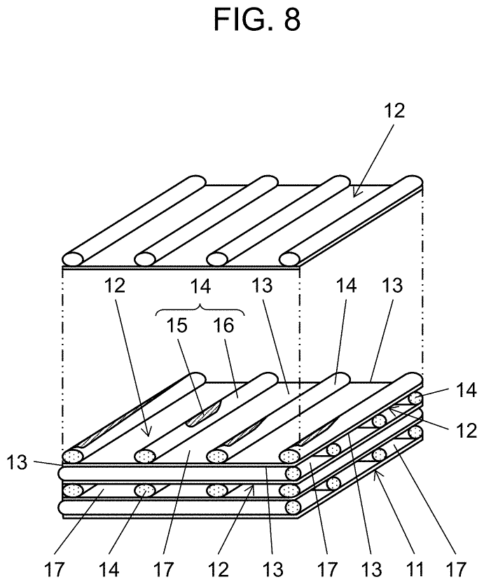

FIG. 9 is a schematic view illustrating an installation state of a heat exchange-type ventilation device according to an exemplary embodiment 2-1 of the present disclosure in a house.

FIG. 10 is a schematic view illustrating a structure of the heat exchange-type ventilation device according to the exemplary embodiment 2-1.

FIG. 11 is a perspective view illustrating a structure of a heat exchange element according to the exemplary embodiment 2-1.

FIG. 12 is an enlarged cross-sectional view illustrating a structure of a rib according to the exemplary embodiment 2-1.

FIG. 13 is a partially enlarged view illustrating an example of assembly of a spacing member and a first reinforcing member according to the exemplary embodiment 2-1.

FIG. 14 is an exploded perspective view illustrating the structure of the heat exchange element according to the exemplary embodiment 2-1.

FIG. 15 is an exploded perspective view illustrating a structure of a heat exchange element according to an exemplary embodiment 2-2 of the present disclosure.

FIG. 16 is a perspective view illustrating the structure of the heat exchange element according to the exemplary embodiment 2-2 of the present disclosure.

FIG. 17 is a perspective view of a conventional heat exchange element.

FIG. 18 is a schematic view illustrating an installation state of a heat exchange-type ventilation device according to an exemplary embodiment 3-1 of the present disclosure in a house.

FIG. 19 is a schematic view illustrating a structure of the heat exchange-type ventilation device according to the exemplary embodiment 3-1.

FIG. 20 is an exploded perspective view illustrating a structure of a heat exchange element according to the exemplary embodiment 3-1.

FIG. 21 is an enlarged cross-sectional view illustrating a structure of a rib according to the exemplary embodiment 3-1.

FIG. 22 is a cross-sectional view illustrating a structure of a rib covered with a heat transfer plate according to the exemplary embodiment 3-1.

FIG. 23 is a view for explaining a method of manufacturing the rib covered with the heat transfer plate according to the exemplary embodiment 3-1.

FIG. 24 is a view for explaining a method for manufacturing the heat exchange element according to the exemplary embodiment 3-1.

FIG. 25 is a cross-sectional view illustrating a structure of a rib in a heat exchange element according to an exemplary embodiment 3-2 of the present disclosure.

FIG. 26 is an exploded perspective view illustrating a structure of a conventional heat exchange element.

### DESCRIPTION OF EMBODIMENTS

The heat exchange element according to the present disclosure includes unit constituent members each of which includes a partition member with heat conductivity and a plurality of spacing members provided on one surface of the partition member, the unit constituent members being laminated to alternately form an exhaust air passage and a supply air passage, wherein an exhaust air flow flowing in the exhaust air passage and a supply air flow flowing in the supply air passage exchange heat via the partition member, the partition member and the spacing member are fixed to each other by an adhesive member, the each of the plurality of spacing members includes a plurality of fiber members with heat meltability and hygroscopicity, and the each of the plurality of spacing members has a fiber melting layer formed by melting and fixing the plurality of fiber members on a surface of the each of the plurality of spacing members.

With such a configuration, rigidity on the surface of the spacing member is improved by the fiber melting layer, so that the spacing member is less likely to be deformed even if an external force or a change in temperature and humidity acts on the heat exchange element. That is, the air passage of the heat exchange element is less likely to be deformed as compared with a case where the fiber melting layer is not provided on the surface of the spacing member. Consequently, the unevenness of air flowing in the heat exchange element is eliminated, and the air is blown at a uniform air speed in the air passage of the heat exchange element, so that the heat exchange efficiency of the heat exchange element can be maintained high. In other words, it is possible to provide a heat exchange element capable of suppressing a decrease in heat exchange efficiency due to a change in the shape of the air passage.

In addition, the spacing member preferably has the fiber melting layer with a planar shape on an adhesive surface with the partition member. As a result, the adhesive area between the spacing member and the partition member increases as compared with a case where the spacing member with a substantially circular cross-section is used, so that the adhesive strength can be increased, and closing of the air passage due to peeling of adhesion between the spacing member and the partition member can be suppressed. That is, it is possible to provide a heat exchange element in which the spacing member is less likely to peel off from the partition member and a decrease in the amount of ventilation can be suppressed.

In addition, it is preferable that a plurality of the fiber members are exposed on a side surface of the spacing member. As a result, the moisture generated in the air passage easily reaches internal fiber members through exposed fiber members, so that the deformation of the partition member due to the moisture in the air passage can be further suppressed. That is, it is possible to provide the heat exchange element capable of suppressing a decrease in heat exchange efficiency due to a change in the shape of the air passage of the heat exchange element.

Moreover, the spacing member may be formed by twisting a plurality of the fiber members. As the fiber members are twisted, the tension of the spacing member increases, the dimensional change in the spacing member due to moisture absorption can be suppressed, and closing of the air passage due to peeling of adhesion between the spacing member and the partition member can be suppressed. That is, it is possible to provide the heat exchange element in which the spacing member is less likely to peel off from the partition member and a decrease in the amount of ventilation can be suppressed.

Further, the heat exchange-type ventilation device according to the present disclosure is configured by mounting the heat exchange element described above therein.

Hereinafter, exemplary embodiments of the present disclosure will be described with reference to the drawings.

### First Exemplary Embodiment

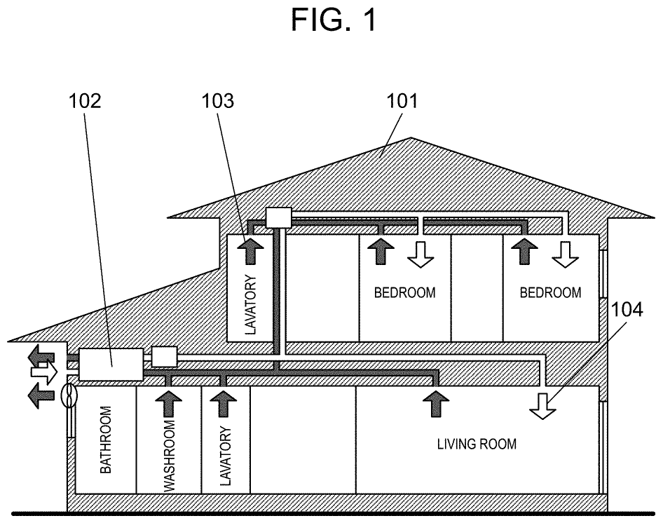

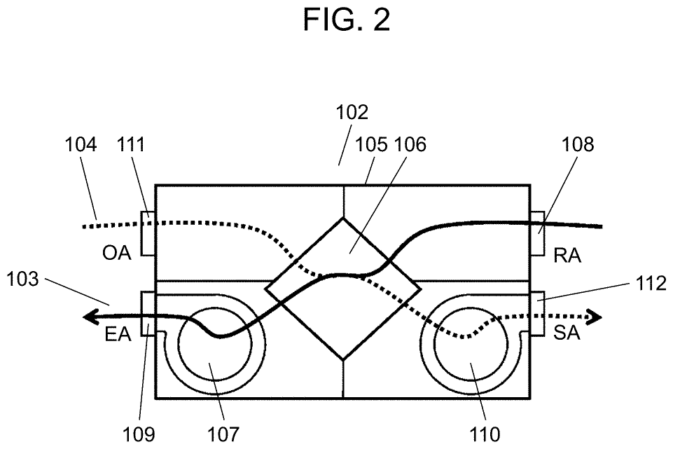

First, an outline of heat exchange-type ventilation device 102 including heat exchange element 106 according to a first exemplary embodiment of the present disclosure will be described with reference to FIGS. 1 and 2. FIG. 1 is a schematic view illustrating an installation example of heat exchange-type ventilation device 102 including heat exchange element 106. FIG. 2 is a schematic view illustrating a structure of heat exchange-type ventilation device 102.

In FIG. 1, heat exchange-type ventilation device 102 is installed inside house 101. Heat exchange-type ventilation device 102 is a device that ventilates indoor air and outdoor air while exchanging heat.

As illustrated in FIG. 1, exhaust air flow 103 is discharged outdoors through heat exchange-type ventilation device 102 as indicated by black arrows. Exhaust air flow 103 is a flow of air exhausted from indoor to outdoor. Supply air flow 104 is introduced into the house through heat exchange-type ventilation device 102 as indicated by white arrows. Supply air flow 104 is a flow of air taken from outdoor to indoor. For example, in winter in Japan, exhaust air flow 103 has a temperature ranging from 20° C. to 25° C., whereas supply air flow 104 reaches below the freezing point in some cases. Heat exchange-type ventilation device 102 performs ventilation, and during ventilation, transfers heat of exhaust air flow 103 to supply air flow 104 to suppress unnecessary release of heat.

As illustrated in FIG. 2, heat exchange-type ventilation device 102 includes body case 105, heat exchange element 106, exhaust fan 107, inside air port 108, exhaust port 109, air supply fan 110, outside air port 111, and air supply port 112. Body case 105 is an outer frame of heat exchange-type ventilation device 102. Inside air port 108, exhaust port 109, outside air port 111, and air supply port 112 are formed on an outer periphery of body case 105. Inside air port 108 is a suction port through which exhaust air flow 103 is sucked into heat exchange-type ventilation device 102. Exhaust port 109 is a discharge port through which exhaust air flow 103 is discharged from heat exchange-type ventilation device 102 to the outdoors. Outside air port 111 is a suction port through which supply air flow 104 is sucked into heat exchange-type ventilation device 102. Air supply port 112 is a discharge port through which supply air flow 104 is discharged from heat exchange-type ventilation device 102 to the indoors.

Heat exchange element 106, exhaust fan 107, and air supply fan 110 are attached to the inside of body case 105. Heat exchange element 106 is a member for exchanging heat between exhaust air flow 103 and supply air flow 104. Exhaust fan 107 is a blower that sucks exhaust air flow 103 from inside air port 108 and discharges exhaust air flow 103 from exhaust port 109. Air supply fan 110 is a blower that sucks supply air flow 104 from outside air port 111 and discharges supply air flow 104 from air supply port 112. By driving exhaust fan 107, exhaust air flow 103 sucked from inside air port 108 passes through heat exchange element 106 and exhaust fan 107, and is discharged from exhaust port 109 to the outdoors. Further, by driving air supply fan 110, supply air flow 104 sucked from outside air port 111 passes through heat exchange element 106 and air supply fan 110, and is supplied from air supply port 112 to the indoors.

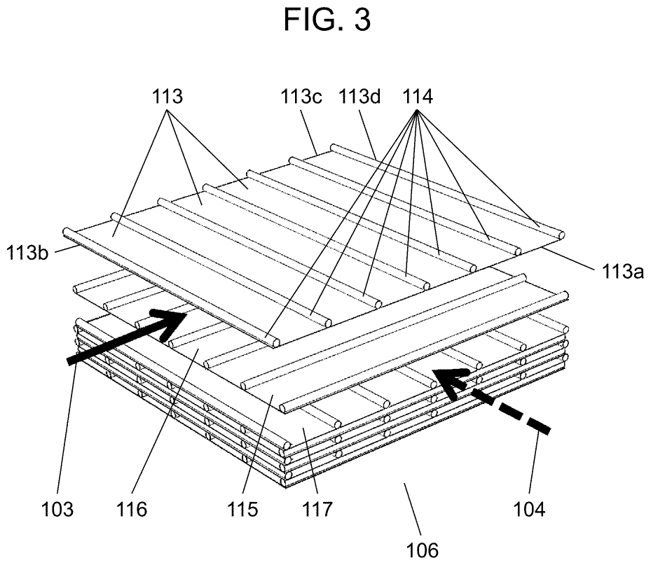

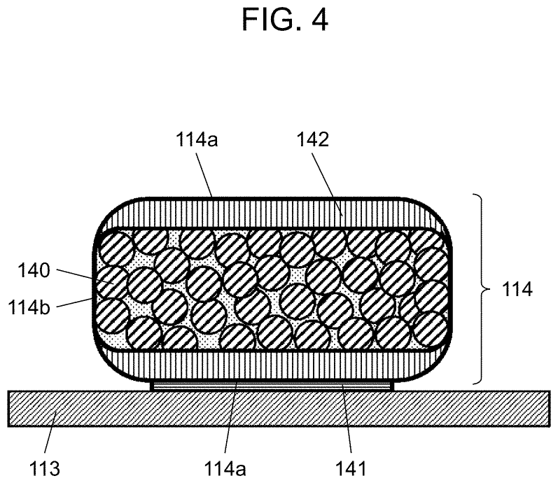

Next, heat exchange element 106 will be described with reference to FIGS. 3 and 4. FIG. 3 is an exploded perspective view illustrating a structure of heat exchange element 106 constituting heat exchange-type ventilation device 102. FIG. 4 is a partial cross-sectional view illustrating a structure of rib 114 constituting heat exchange element 106.

As illustrated in FIG. 3, heat exchange element 106 includes a plurality of heat exchange element pieces 115. In each heat exchange element piece 115, a plurality of ribs 114 are adhered onto one surface of substantially square heat transfer plate 113. Heat exchange element 106 is formed by laminating the plurality of heat exchange element pieces 115 while alternately changing the direction such that ribs 114 are orthogonal to each other. With such a configuration, exhaust air passage 116 through which exhaust air flow 103 passes and supply air passage 117 through which supply air flow 104 passes are formed, and exhaust air flow 103 and supply air flow 104 alternately flow orthogonally and can exchange heat.

Heat exchange element piece 115 is one unit that constitutes heat exchange element 106. Heat exchange element piece 115 is formed by adhering the plurality of ribs 114 on one surface of substantially square heat transfer plate 113. Rib 114 on heat transfer plate 113 is formed such that the longitudinal direction extends from one end side of heat transfer plate 113 toward the other end side opposing the one end side. Respective ribs 114 are arranged in parallel on the surface of heat transfer plate 113 at predetermined intervals. Specifically, as illustrated in FIG. 3, on one surface of heat transfer plate 113 constituting one of two vertically adjacent heat exchange element pieces 115, ribs 114 are adhered such that the longitudinal direction of rib 114 extends from end side 113a of heat transfer plate 113 toward end side 113c opposing end side 113a. Further, on one surface of heat transfer plate 113 constituting another heat exchange element piece 115, ribs 114 are adhered such that the longitudinal direction of rib 114 extends from end side 113b (perpendicular to end side 113a) of heat transfer plate 113 toward end side 113d opposing end side 113b.

Heat transfer plate 113 is a plate-like member for exchanging heat when exhaust air flow 103 and supply air flow 104 flow with heat transfer plate 113 being interposed therebetween. Heat transfer plate 113 is formed of a heat transfer paper based on cellulose fiber, and has heat conductivity, moisture permeability, and hygroscopicity. However, the material of heat transfer plate 113 is not limited thereto. As heat transfer plate 113, for example, a moisture-permeable resin film based on polyurethane or polyethylene terephthalate, a paper material based on cellulose fiber, ceramic fiber, glass fiber, or the like can be used. As heat transfer plate 113, a thin sheet that has heat conductivity and does not allow air to permeate can be used.

The plurality of ribs 114 are provided between a pair of opposing sides of heat transfer plate 113, and are formed from one end side toward the other end side. Rib 114 is a member for forming a gap in which exhaust air flow 103 or supply air flow 104 passes between heat transfer plates 113 when heat transfer plates 113 are laminated, that is, exhaust air passage 116 or supply air passage 117.

As illustrated in FIG. 4, each of the plurality of ribs 114 has a substantially flat shape with a flat cross-section (plane 114a). Rib 114 is configured to include a plurality of fiber members 140 and fiber melting layer 142 in which fiber members 140 are melted and welded to each other on the surface of rib 114. Specifically, rib 114 is configured to include a body formed by twisting the plurality of fiber members 140 and fiber melting layer 142 formed in a portion of plane 114a of the body opposing heat transfer plate 113, and the body (the plurality of fiber members 140) is exposed on side surface 114b of rib 114. Rib 114 is fixed to heat transfer plate 113 via adhesive member 141 at the portion of plane 114a (a portion of fiber melting layer 142) of rib 114. Note that FIG. 4 illustrates a state where the portion of lower plane 114a is fixed to underlying heat transfer plate 113 by adhesive member 141. However, as described later, the portion of upper plane 114a is also fixed to overlying heat transfer plate 113 by adhesive member 141.

Each of fiber members 140 is a member that has a substantially circular cross-section and extends in the same direction as rib 114. The plurality of fiber members 140 are twisted in a predetermined direction to constitute rib 114. As a material of fiber member 140, any material that has heat meltability and hygroscopicity, and also has a certain strength can be used, and a resin member such as vinylon, polypropylene, polyethylene, polyethylene terephthalate, or polyamide can be used.

Fiber melting layer 142 is a melting layer in which the plurality of fiber members 140 are melted and welded (fixed) to each other, and is selectively formed on the portion of plane 114a of rib 114. Since fiber members 140 are melted to each other, the rigidity of fiber melting layer 142 is improved. As a result, the rigidity of rib 114 is also improved.

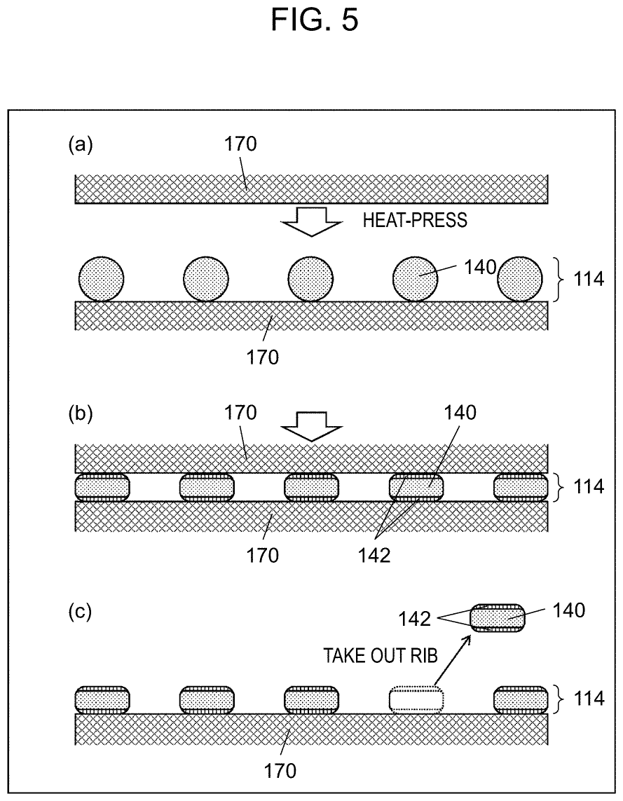

Next, a method of manufacturing rib 114 having fiber melting layer 142 will be described with reference to FIG. 5. FIG. 5 is a view for explaining the method of manufacturing rib 114 having fiber melting layer 142. Here, parts (a) to (c) of FIG. 5 illustrate steps of manufacturing rib 114 in a manufacturing process of heat exchange element 106. That is, part (a) of FIG. 5 illustrates a first step of attaching rib 114 composed of the plurality of fiber members 140 to heat press machine 170. Part (b) of FIG. 5 illustrates a second step of heat-pressing rib 114 composed of the plurality of fiber members 140 to form rib 114 having fiber melting layer 142. Part (c) of FIG. 5 illustrates a third step of removing rib 114 having fiber melting layer 142 from heat press machine 170. Hereinafter, the contents of each step will be specifically described.

First, as the first step, as illustrated in part (a) of FIG. 5, ribs 114 with a substantially circular shape (ribs 114 composed the plurality of fiber members 140 in which fiber melting layer 142 is not formed) are arranged at predetermined positions on the upper surface of a base of heat press machine 170.

Next, as the second step, as illustrated in part (b) of FIG. 5, the press plate of heat press machine 170 is pressed against ribs 114 with a substantially circular shape from above, and the base and the press plate of heat press machine 170 are heated. Specifically, by pressing ribs 114 by heat press machine 170, ribs 114 are crushed in a pressing direction, and the cross-section of each rib 114 is changed to a flat shape. At this time, by heating the pressed surface, fiber members 140 at the portion where the base of heat press machine 170 and the press plate are in contact with each other (the portion that becomes plane 114a of rib 114) are melted (welded), and fiber melting layer 142 is selectively formed. Heating of the base and the press plate of heat press machine 170 is then stopped.

Here, as the press means, a known method can be used, and examples thereof include flat plate press and roll press. In this case, by adjusting the position of the press plate of heat press machine 170 in the pressing direction (the space between the press plate and the base), the width and height of rib 114 having fiber melting layer 142 (the height of the air passage of heat exchange element 106) can be easily adjusted. It is preferable that the press plate and the base are substantially parallel to each other because, when fiber melting layer 142 adheres to heat transfer plate 113, fiber melting layer 142 can have a planar shape substantially parallel to the adhesive surface of heat transfer plate 113, and heat transfer plates 113 can be more easily kept parallel to each other.

As the heating means, a known method can be used, and examples thereof include non-contact heating by hot air, flame, or electromagnetic induction, and contact heating by a heater. In a case where pressing is involved, contact heating is particularly preferable. In the present exemplary embodiment, fiber melting layer 142 is formed by heating and pressing, but fiber melting layer 142 may be formed by pressing a material once heated and melted before re-curing. At this time, the shape at the time of pressing can be further fixed by simultaneously performing cooling at the time of pressing.

Finally, as the third step, as illustrated in part (c) of FIG. 5, the press plate of heat press machine 170 is removed upward, and ribs 114 having fiber melting layer 142 are taken out one by one from the base.

As described above, rib 114 is manufactured in which fiber melting layer 142 where the plurality of fiber members 140 are melted and fixed is selectively formed on the surface (the portion of plane 114a).

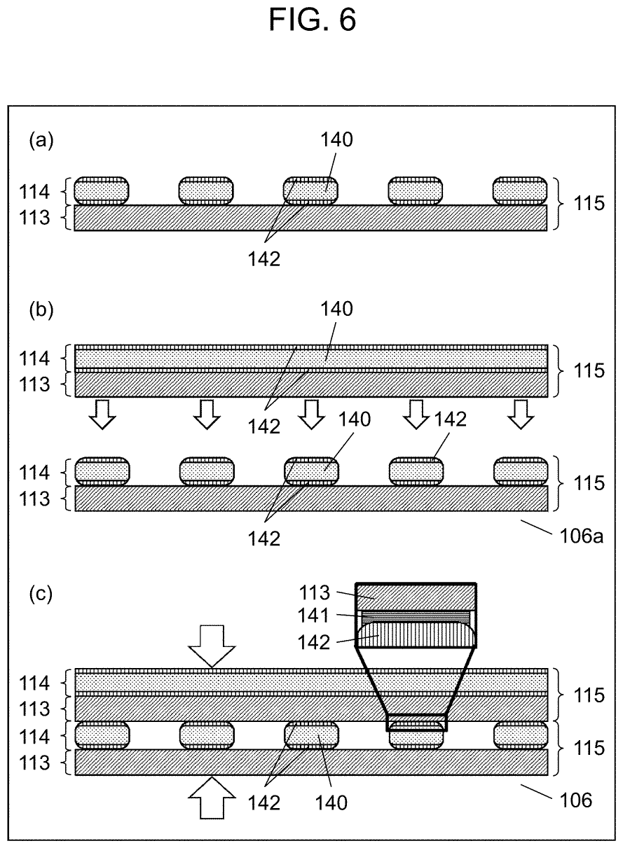

Next, a method of manufacturing heat exchange element 106 according to the first exemplary embodiment will be described with reference to FIG. 6. FIG. 6 is a view for explaining the method of manufacturing heat exchange element 106. Here, parts (a) to (c) of FIG. 6 illustrate steps of manufacturing heat exchange element 106 performed following the steps of manufacturing rib 114. That is, part (a) of FIG. 6 illustrates a fourth step of forming heat exchange element piece 115. Part (b) of FIG. 6 illustrates a fifth step of laminating heat exchange element pieces 115 to form a laminate. Part (c) of FIG. 6 illustrates a sixth step of compressing the laminate in a laminating direction to form heat exchange element 106. Hereinafter, the contents of each step will be specifically described.

First, as the fourth step, as illustrated in part (a) of FIG. 6, the plurality of ribs 114 (ribs 114 having fiber melting layer 142) manufactured through the first step to third step described above are arranged at predetermined positions on one surface of heat transfer plate 113. Rib 114 is then fixed by adhesive member 141 (not illustrated in FIG. 6) applied to fiber melting layer 142 on the lower surface side (the portion of plane 114a on the lower surface side illustrated in FIG. 4) of rib 114. As a result, heat exchange element piece 115 having the plurality of ribs 114 (ribs 114 having fiber melting layer 142) on one surface of heat transfer plate 113 is formed.

Next, as the fifth step, as illustrated in part (b) of FIG. 6, a plurality of heat exchange element pieces 115 are laminated while alternately changing the direction vertically such that ribs 114 are orthogonal to each other, so that laminate 106a, which is a precursor of heat exchange element 106, is formed. In this case, adhesive member 141 (not illustrated in part (b) of FIG. 6) is applied to fiber melting layer 142 on the upper surface side of rib 114 (the portion of plane 114a on the upper surface side illustrated in FIG. 4).

Finally, as the sixth step, as illustrated in part (c) of FIG. 6, laminate 106a is compressed from the laminating direction (vertical direction) of heat exchange element pieces 115 to form heat exchange element 106 in which air passages (exhaust air passage 116, supply air passage 117) with a predetermined space (a space corresponding to the height of rib 114) in the laminating direction are formed. In this case, rib 114 is fixed to heat transfer plate 113 of another heat exchange element piece 115 (upper heat exchange element piece 115 in part (c) of FIG. 6) by adhesive member 141 applied to rib 114.

As described above, heat exchange element 106 having rib 114 on which fiber melting layer 142 is selectively formed is manufactured.

Here, problems of the prior art will be described again with reference to FIGS. 3 and 4.

In a season with low outdoor humidity such as winter in Japan, the humidity of supply air flow 104 is lower than that of exhaust air flow 103. For this reason, when the water vapor in the air carried on exhaust air flow 103 passes through exhaust air passage 116, the water vapor adheres to rib 114 that forms exhaust air passage 116, fiber member 140 absorbs the water vapor, and fiber member 140 expands in a longitudinal direction and a fiber diameter direction. At this time, since a dimensional change occurs between rib 114 and heat transfer plate 113, adhesive member 141 breaks and peels off in the conventional heat exchange element. As ribs 114 are peeled off from heat transfer plate 113 through which exhaust air flow 103 flows, the pressure of supply air flow 104 flowing below heat transfer plate 113 through which exhaust air flow 103 flows in FIG. 3 is applied, heat transfer plate 113 through which exhaust air flow 103 flows is deflected, and exhaust air passage 116 is closed. If exhaust air passage 116 is partially closed, the air volume partially decreases, and exhaust air flow 103 flows with a non-uniform air volume balance with respect to heat transfer plate 113, so that the heat exchange efficiency decreases in the conventional heat exchange element.

On the other hand, heat exchange element 106 according to the first exemplary embodiment is configured by using rib 114 in which fiber melting layer 142 is formed on the surface as rib 114 that constitutes the air passage (exhaust air passage 116, supply air passage 117). Consequently, it is possible to suppress peeling of adhesion caused by dimensional changes in heat transfer plate 113 and rib 114 due to absorption of moisture in the air of exhaust air flow 103, and it is also possible to suppress closing of exhaust air passage 116. Therefore, the unevenness of the air flowing in heat exchange element 106 is eliminated, and the air is blown at a uniform air speed in exhaust air passage 116 of heat exchange element 106, so that the heat exchange efficiency can be maintained high.

As described above, according to heat exchange element 106 of the first exemplary embodiment, the following effects can be obtained.

(1) Heat exchange element 106 is constituted by the plurality of ribs 114 each of which has, on the surface, fiber melting layer 142 in which the plurality of fiber members 140 are melted and fixed. As a result, the rigidity on the surface of rib 114 is improved, so that rib 114 is less likely to be deformed even if an external force or a change in temperature and humidity acts on heat exchange element 106. That is, the air passage of heat exchange element 106 is less likely to be deformed as compared with the case where fiber melting layer 142 is not provided on the surface of rib 114. Therefore, the unevenness of the air flowing in heat exchange element 106 is eliminated, and the air is blown at a uniform air speed in the air passage of heat exchange element 106, so that the heat exchange efficiency of the heat exchange element can be maintained high. In other words, it is possible to provide heat exchange element 106 capable of suppressing a decrease in heat exchange efficiency due to a change in the shape of the air passage.

(2) Rib 114 is configured to include fiber melting layer 142 with a planar shape (plane 114a) on the adhesive surface with heat transfer plate 113. As a result, the adhesive area between rib 114 and heat transfer plate 113 increases as compared with a case where rib 114 with a substantially circular cross-section is used, so that the adhesive strength can be increased. Consequently, it is possible to suppress closing of the air passage (exhaust air passage 116, supply air passage 117) due to peeling of adhesion between rib 114 and heat transfer plate 113. That is, it is possible to provide heat exchange element 106 in which rib 114 is less likely to peel off from heat transfer plate 113 and a decrease in the amount of ventilation can be suppressed.

(3) Rib 114 is configured by exposing the plurality of fiber members 140 on side surface 114b of rib 114. As a result, the moisture generated in the air passage easily reaches internal fiber members 140 through exposed fiber members 140, so that the deformation of heat transfer plate 113 due to the moisture in the air passage can be suppressed. That is, it is possible to provide heat exchange element 106 capable of suppressing a decrease in heat exchange efficiency due to a change in the shape of the air passage of heat exchange element 106.

(4) Rib 114 is formed by twisting the plurality of fiber members 140. That is, as fiber members 140 are twisted, the tension of rib 114 increases, the dimensional change in rib 114 due to moisture absorption can be suppressed, and closing of the air passage due to peeling of adhesion between rib 114 and heat transfer plate 113 can be suppressed. That is, it is possible to provide heat exchange element 106 in which rib 114 is less likely to peel off from heat transfer plate 113 and a decrease in the amount of ventilation can be suppressed.

(5) By configuring a heat exchange-type ventilation device using heat exchange element 106 according to the first exemplary embodiment, it is possible to achieve a heat exchange-type ventilation device capable of suppressing a decrease in heat exchange efficiency due to a change in the shape of the air passage of heat exchange element 106.

### (Modifications)

The present disclosure has been described above based on the exemplary embodiments. It will be understood by those skilled in the art that the exemplary embodiments are merely examples, modifications in which components or processes of the exemplary embodiments are variously combined are possible, and these modifications still fall within the scope of the present disclosure.

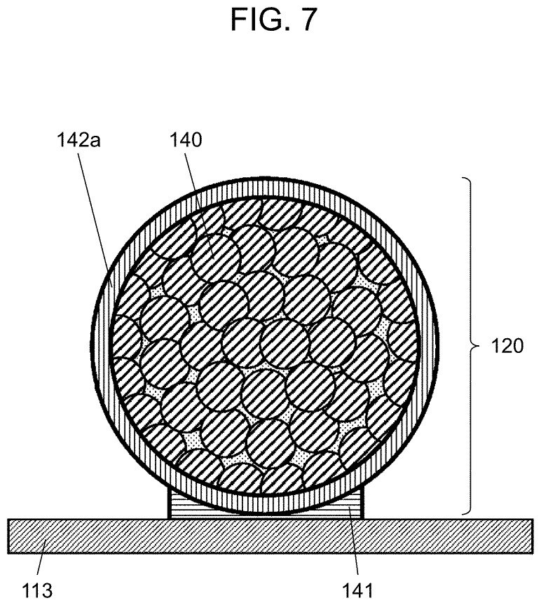

In heat exchange element 106 according to the present exemplary embodiment, fiber melting layer 142 is provided only on the portion of plane 114a of flat rib 114, but the present disclosure is not limited thereto. For example, as illustrated in FIG. 7, rib 120 may be configured such that fiber melting layer 142a is provided on the entire surface of substantially circular rib 120. Other configurations of the heat exchange element according to the modification are similar to those of heat exchange element 106. This configuration will be described with reference to FIG. 7.

FIG. 7 is a partial cross-sectional view illustrating a structure of rib 120 of a heat exchange element according to a modification. Rib 120 constituting the heat exchange element according to the modification includes a substantially circular body (a plurality of fiber members 140) and fiber melting layer 142a covering the entire surface of the body. That is, rib 120 has a configuration in which fiber members 140 twisted are not exposed on the surface. In this case, although moisture absorption into rib 120 passing through the space between fiber members 140 is suppressed, but rigidity on the surface of rib 120 is further improved, so that rib 120 is further less likely to be deformed even if an external force or a change in temperature and humidity acts on heat exchange element 106. That is, the heat exchange element according to the modification is capable of further suppressing a decrease in heat exchange efficiency due to a change in the shape of the air passage.

In addition, by configuring a heat exchange-type ventilation device using the heat exchange element according to the modification, it is possible to provide a heat exchange-type ventilation device capable of further suppressing a decrease in heat exchange efficiency due to a change in the shape of the air passage of the heat exchange element, as in (5) described above.

As a further modification, it may be configured in the body of rib 120 such that the adhesive member having lower hygroscopicity than fiber member 140 is impregnated into the space formed by twisting the plurality of fiber members 140. As a result, even if fiber member 140 absorbs moisture and attempts to change in dimension due to expansion, the adhesive member with low hygroscopicity is fixed, so that the dimensional change in rib 120 can be further suppressed. As the adhesive member with low hygroscopicity, for example, an adhesive containing no hydrophilic group (for example, a hydroxy group or the like) in a monomer based on a solution-based adhesive (phenol resin or the like) or a solvent-free adhesive (epoxy resin or the like) cured by a chemical reaction can be used.

Regarding the wording used above, heat exchange element 106 of the first exemplary embodiment and the heat exchange element of the modification correspond to “heat exchange element” in the claims. Further, heat transfer plate 113 of the first exemplary embodiment and the modification corresponds to “partition member” in the claims, and rib 114 of the first exemplary embodiment and rib 120 of the modification correspond to “spacing member” in the claims. Furthermore, heat exchange element piece 115 of the first exemplary embodiment and the heat exchange element piece of the modification correspond to “unit constituent member” in the claims. Moreover, fiber member 140 of the first exemplary embodiment and the modification corresponds to “fiber member” in the claims, adhesive member 141 corresponds to “adhesive member” in the claims, and fiber melting layer 142 of the first exemplary embodiment and fiber melting layer 142a of the modification correspond to “fiber melting layer” in the claims. Further, heat exchange-type ventilation device 102 of the first exemplary embodiment and the heat exchange-type ventilation device of the modification correspond to “heat exchange-type ventilation device” in the claims. Furthermore, exhaust air flow 103 of the first exemplary embodiment and the modification corresponds to “exhaust air flow” in the claims, supply air flow 104 corresponds to “supply air flow” in the claims, exhaust air passage 116 corresponds to “exhaust air passage” in the claims, and supply air passage 117 corresponds to “supply air passage” in the claims.

### Second Exemplary Embodiment

Conventionally, the following has been known as a structure of a heat exchange element that is used in a heat exchange-type ventilation device in order to secure reliability as a result of an improvement in sealability (a sealing function to prevent air flowing in an air flow path from leaking to the outside) (see, for example, PTL 1).

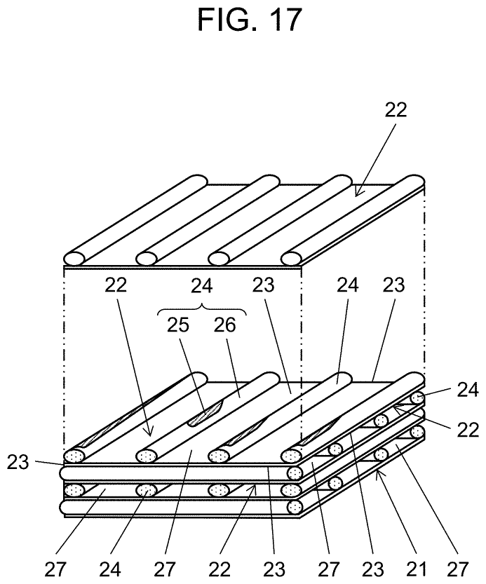

FIG. 17 is an exploded perspective view illustrating a structure of conventional heat exchange element 21.

As illustrated in FIG. 17, heat exchange element 21 is configured by laminating a large number of heat exchange element units 22 including functional papers 23 with heat conductivity and ribs 24. On one surface of functional paper 23, a plurality of ribs 24 composed of paper string 25 and hot melt resin 26 that adheres paper string 25 to functional paper 23 are provided in parallel at predetermined intervals. This rib 24 creates a gap between a pair of functional papers 23 laminated adjacent to each other, thereby forming air flow path 27. Heat exchange element 21 is configured such that a plurality of gaps are stacked, and blowing directions of respective air flow paths 27 in adjacent gaps are orthogonal to each other. As a result, in air flow path 27, the supply air flow and the exhaust air flow are alternately ventilated every functional paper 23, and heat is exchanged between the supply air flow and the exhaust air flow.

As described above, conventional heat exchange element 21 has a configuration in which rib 24 is formed by covering paper string 25 with a substantially circular cross-section with hot melt resin 26, and rib 24 formed maintains the space between functional papers 23. However, since paper string 25 has low rigidity, paper string 25 is easily deformed by an external force or the like, and ribs 24 peel off from functional paper 23, so that the strength of heat exchange element 21 decreases. That is, the conventional heat exchange element has a problem that the spacing member (for example, the rib described above) peels off from the partition member (for example, the functional paper described above) by an external force or the like generated on the outer peripheral surface of the heat exchange element, so that the strength of the heat exchange element decreases.

Therefore, an object of the present disclosure is to provide a heat exchange element that suppresses peeling of a spacing member from a partition member on the outer peripheral portion of the heat exchange element due to an external force generated on the outer peripheral surface to increase strength, and a heat exchange-type ventilation device using the heat exchange element.

In order to achieve this object, the heat exchange element according to the present disclosure includes unit constituent members each of which includes a partition member with heat conductivity and a plurality of spacing members provided in parallel on one surface of the partition member, the unit constituent members being laminated to alternately form an exhaust air passage and a supply air passage, wherein an exhaust air flow flowing in the exhaust air passage and a supply air flow flowing in the supply air passage exchange heat via the partition member. The spacing member has a projection that extends outward from an end side of the partition member. For the projection, a first reinforcing member that connects the projections adjacent to each other in the laminating direction of the unit constituent members is formed, so that the desired object is achieved.

According to the present disclosure, it is possible to obtain a heat exchange element with high strength in which peeling of the spacing member from the partition member is suppressed, and a heat exchange-type ventilation device using the heat exchange element.

The heat exchange element according to the present disclosure includes unit constituent members each of which includes a partition member with heat conductivity and a plurality of spacing members provided in parallel on one surface of the partition member, the unit constituent members being laminated to alternately form an exhaust air passage and a supply air passage, wherein an exhaust air flow flowing in the exhaust air passage and a supply air flow flowing in the supply air passage exchange heat via the partition member, the spacing member has a projection that extends outward from an end side of the partition member, and for the projection, the first reinforcing member that connects the projections adjacent to each other in the laminating direction of the unit constituent members is formed.

More specifically, as the spacing members adjacent to each other in the laminating direction of the unit constituent members are connected via the first reinforcing member, the positions of the partition member and the spacing member can be fixed, so that the strength can be improved. Even in a case where an external force is generated on the outer peripheral surface of the heat exchange element, the first reinforcing member functions as a cushion material and distributes the external force to reduce the external force transmitted to the partition member and the spacing member. Consequently, it is possible to obtain the heat exchange element with high strength in which peeling of the spacing reinforcement member from the partition member is suppressed in a case where an external force is generated on the outer peripheral surface of the heat exchange element.

In addition, the heat exchange element according to the present disclosure may further include a second reinforcing member that connects the first reinforcing members adjacent to each other, and the second reinforcing member may be provided along the spacing members located on the end side of the partition member. As a result, the positions of the first reinforcing members adjacent to each other can be fixed by the second reinforcing member, and the positions of the partition member and the spacing member can be further fixed. In addition, as compared with the configuration in which only the first reinforcing member is provided, even in a case where an external force is generated on the outer peripheral surface of the heat exchange element, the external force can be distributed, and the external force transmitted to the partition member and the spacing member can be further reduced.

Furthermore, in the heat exchange element according to the present disclosure, at least one of the first reinforcing member and the second reinforcing member may be configured to have higher rigidity than the spacing member. As a result, even in a case where an external force is generated on the outer peripheral surface of the heat exchange element, at least one of the first reinforcing member and the second reinforcing member can absorb the external force and reduce the external force transmitted to the spacing member.

Furthermore, in the heat exchange element according to the present disclosure, at least one of the first reinforcing member and the second reinforcing member may be configured to have higher hygroscopicity than the spacing member. As a result, in a case where air is ventilated in a high-humidity environment accompanied by dew condensation, moisture entering the air passage can be reduced by at least one of the first reinforcing member and the second reinforcing member, and softening of the spacing member due to moisture absorption can be suppressed.

Further, the heat exchange-type ventilation device according to the present disclosure is configured by mounting the heat exchange element described above therein.

Hereinafter, exemplary embodiments of the present disclosure will be described with reference to the drawings. A second exemplary embodiment includes at least the following exemplary embodiment 2-1 and exemplary embodiment 2-2.

### Exemplary Embodiment 2-1

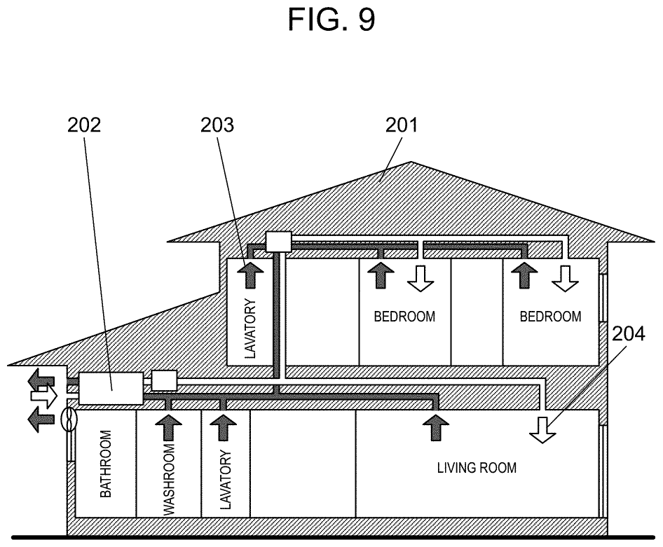

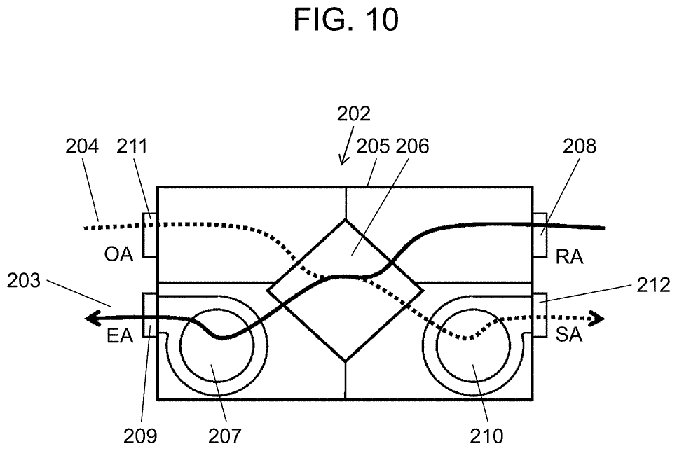

First, an outline of heat exchange-type ventilation device 202 including heat exchange element 206 according to the exemplary embodiment 2-1 of the present disclosure will be described with reference to FIGS. 9 and 10. FIG. 9 is a schematic view illustrating an installation example of heat exchange-type ventilation device 202 including heat exchange element 206. FIG. 10 is a schematic diagram illustrating a structure of heat exchange-type ventilation device 202.

In FIG. 9, heat exchange-type ventilation device 202 is installed inside house 201. Heat exchange-type ventilation device 202 is a device that ventilates indoor air and outdoor air while exchanging heat.

As illustrated in FIG. 9, exhaust air flow 203 is discharged outdoors through heat exchange-type ventilation device 202 as indicated by black arrows. Exhaust air flow 203 is a flow of air exhausted from indoor to outdoor. Supply air flow 204 is introduced into the house through heat exchange-type ventilation device 202 as indicated by white arrows. Supply air flow 204 is a flow of air taken from outdoor to indoor. For example, in winter in Japan, exhaust air flow 203 has a temperature ranging from 20° C. to 25° C., whereas supply air flow 204 reaches below the freezing point in some cases. Heat exchange-type ventilation device 202 performs ventilation, and during ventilation, transfers heat of exhaust air flow 203 to supply air flow 204 to suppress unnecessary release of heat.

As illustrated in FIG. 10, heat exchange-type ventilation device 202 includes body case 205, heat exchange element 206, exhaust fan 207, inside air port 208, exhaust port 209, air supply fan 210, outside air port 211, and air supply port 212. Body case 205 is an outer frame of heat exchange-type ventilation device 202. Inside air port 208, exhaust port 209, outside air port 211, and air supply port 212 are formed on an outer periphery of body case 205. Inside air port 208 is a suction port through which exhaust air flow 203 is sucked into heat exchange-type ventilation device 202. Exhaust port 209 is a discharge port through which exhaust air flow 203 is discharged from heat exchange-type ventilation device 202 to the outdoors. Outside air port 211 is a suction port through which supply air flow 204 is sucked into heat exchange-type ventilation device 202. Air supply port 212 is a discharge port through which supply air flow 204 is discharged from heat exchange-type ventilation device 202 to the indoors.

Heat exchange element 206, exhaust fan 207, and air supply fan 210 are attached to the inside of body case 205. Heat exchange element 206 is a member for exchanging heat between exhaust air flow 203 and supply air flow 204. Exhaust fan 207 is a blower that sucks exhaust air flow 203 from inside air port 208 and discharges exhaust air flow 203 from exhaust port 209. Air supply fan 210 is a blower that sucks supply air flow 204 from outside air port 211 and discharges supply air flow 204 from air supply port 212. By driving exhaust fan 207, exhaust air flow 203 sucked from inside air port 208 passes through heat exchange element 206 and exhaust fan 207, and is discharged from exhaust port 209 to the outdoors. Further, by driving air supply fan 210, supply air flow 204 sucked from outside air port 211 passes through heat exchange element 206 and air supply fan 210, and is supplied from air supply port 212 to the indoors.

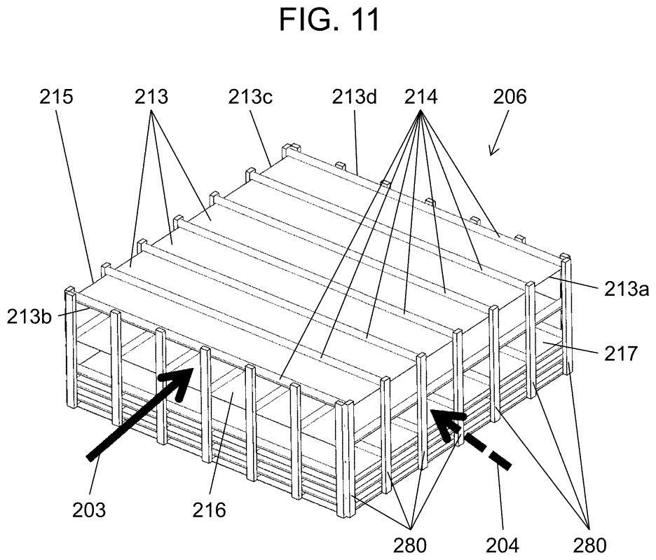

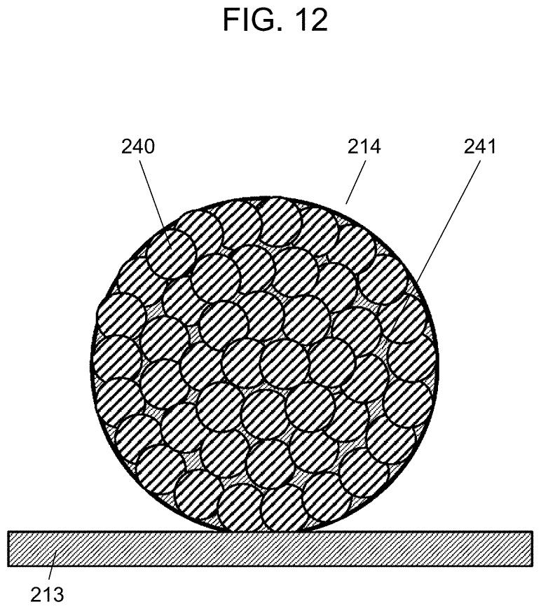

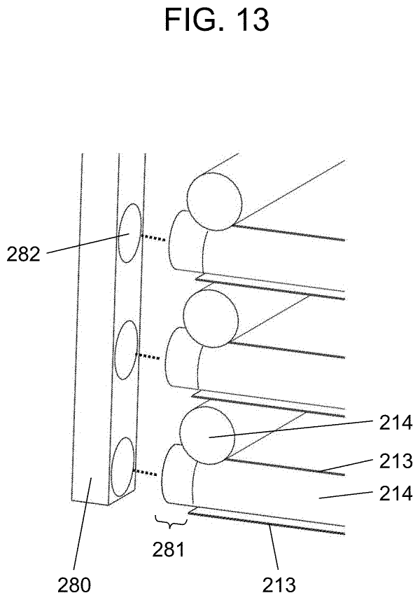

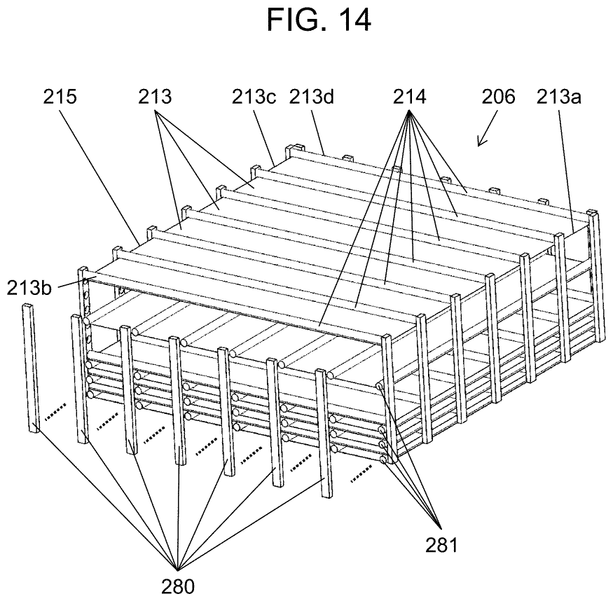

Next, heat exchange element 206 will be described with reference to FIGS. 11 to 14. FIG. 11 is a perspective view illustrating a structure of heat exchange element 206. FIG. 12 is an enlarged cross-sectional view illustrating a structure of rib 214. FIG. 13 is a partially enlarged view illustrating an example of assembly of rib 214 and first reinforcing rib 280 constituting heat exchange element 206. FIG. 14 is an exploded perspective view illustrating the structure of heat exchange element 206.

As illustrated in FIG. 11, heat exchange element 206 includes a plurality of heat exchange element pieces 215. In each heat exchange element piece 215, a plurality of ribs 214 are adhered onto one surface of substantially square heat transfer plate 213. Heat exchange element 206 is formed by laminating the plurality of heat exchange element pieces 215 while alternately changing the direction such that ribs 214 are orthogonal to each other. With such a configuration, exhaust air passage 216 through which exhaust air flow 203 passes and supply air passage 217 through which supply air flow 204 passes are formed, and exhaust air flow 203 and supply air flow 204 alternately flow orthogonally and can exchange heat.

Heat exchange element piece 215 is one unit that constitutes heat exchange element 206. As described above, heat exchange element piece 215 is formed by adhering the plurality of ribs 214 on one surface of substantially square heat transfer plate 213. Rib 214 on heat transfer plate 213 is formed such that the longitudinal direction extends from one end side of heat transfer plate 213 toward the other end side opposing the one end side. Each of the plurality of ribs 214 is linearly formed. Respective ribs 214 are arranged in parallel on the surface of heat transfer plate 213 at predetermined intervals. Specifically, as illustrated in FIG. 11, on one surface of heat transfer plate 213 constituting one of two vertically adjacent heat exchange element pieces 215, ribs 214 are adhered such that the longitudinal direction of rib 214 extends from end side 213a of heat transfer plate 213 toward end side 213c opposing end side 213a. Further, on one surface of heat transfer plate 213 constituting another heat exchange element piece 215, ribs 214 are adhered such that the longitudinal direction of rib 214 extends from end side 213b (perpendicular to end side 213a) of heat transfer plate 213 toward end side 213d opposing end side 213b.

Heat transfer plate 213 is a plate-like member for exchanging heat when exhaust air flow 203 and supply air flow 204 flow with heat transfer plate 213 being interposed therebetween. Heat transfer plate 213 is formed of a heat transfer paper based on cellulose fiber, and has heat conductivity, moisture permeability, and hygroscopicity. However, the material of heat transfer plate 213 is not limited thereto. As heat transfer plate 213, for example, a moisture-permeable resin film based on polyurethane or polyethylene terephthalate, a paper material based on cellulose fiber, ceramic fiber, or glass fiber, or the like can be used. As heat transfer plate 213, a thin sheet that has heat conductivity and does not allow air to permeate can be used.

The plurality of ribs 214 are provided between a pair of opposing sides of heat transfer plate 213, and are formed from one end side toward the other end side. Rib 214 is a substantially columnar member for forming a gap in which exhaust air flow 203 or supply air flow 204 passes between heat transfer plates 213 when heat transfer plates 213 are laminated, that is, exhaust air passage 216 or supply air passage 217.

As illustrated in FIG. 12, each of the plurality of ribs 214 has a substantially circular cross-section. The member that has a substantially flat shape, a rectangular shape, a hexagonal shape, or the like as the cross-sectional shape of rib 214 in addition to the substantially circular shape may be used. Rib 214 includes a plurality of fiber members 240, and is fixed to heat transfer plate 213. Further, rib 214 is formed by impregnating fine voids between fiber members 240 with adhesive 241. To fix rib 214 to heat transfer plate 213, a known adhesive or adhesion method can be used according to the material of rib 214, such as application of an adhesive, bonding of a sealing material, or heat welding, and there is no difference in the effect.

As illustrated in FIG. 12, each of fiber members 240 is a fiber member that has a substantially circular cross-section and extends in the same direction as rib 214. As a material of fiber member 240, any material that has hygroscopicity and also has a certain strength can be used, and a resin member such as polypropylene, polyethylene, polyethylene terephthalate, or polyamide, a paper material based on cellulose fiber, ceramic fiber, or glass fiber, cotton, silk, or hemp can be used.

Further, as illustrated in FIG. 13, ribs 214 extend from the end side (end side 213a to end side 213d) of heat transfer plate 213 toward the outer peripheral direction of heat exchange element piece 215 (heat exchange element 206). That is, rib 214 is formed so as to project outward from the end side of heat transfer plate 213. Here, the extending portion of rib 214 from the end side of heat transfer plate 213 to the end (distal end) of rib 214 is defined as rib projection 281.

As illustrated in FIGS. 11 and 13, with respect to rib projection 281, first reinforcing rib 280 is provided on the outer peripheral surface of heat exchange element 206. First reinforcing rib 280 connects rib projections 281 adjacent to each other in the laminating direction (the vertical direction in FIG. 11) of heat exchange element pieces 215.

As illustrated in FIGS. 13 and 14, first reinforcing rib 280 is a member that connects rib projections 281 of ribs 214 adjacent in the laminating direction of heat exchange element pieces 215 to fix the arrangement of ribs 214. On the side surface of first reinforcing rib 280 in contact with rib projection 281, first reinforcing rib 280 includes recesses 282 into which rib projections 281 can be fitted as many as half of a number of heat exchange element pieces 215 laminated, that is, as many as the number of heat exchange element pieces 215 with the same air passage direction. By fitting rib projection 281 into recess 282, first reinforcing rib 280 is fixed to rib 214. Here, in a case where the lateral width of first reinforcing rib 280 is larger than the lateral width of rib 214, the air passages of exhaust air passage 216 and supply air passage 217 are narrowed, so that the lateral width of first reinforcing rib 280 is substantially equal to the lateral width of rib 214. The material of first reinforcing rib 280 is desirably a material with high rigidity, and for example, a resin member such as polypropylene, polyethylene, polyethylene terephthalate, or polyamide, or a ceramic, glass, or metal material can be used. In particular, the metal material generally has high rigidity, and is suitable in the present configuration.

As described above, according to heat exchange element 206 of the present exemplary embodiment 2-1, the following effects can be obtained.

(1) As ribs 214 adjacent to each other in the laminating direction of heat exchange element pieces 215 are connected to each other via first reinforcing ribs 280, the positions of heat transfer plates 213 and ribs 214 can be fixed as compared with a case where ribs 214 are independently adhered to heat transfer plates 213. As a result, the joint strength between heat transfer plate 213 and rib 214 can be improved. Specifically, the joint strength between heat transfer plate 213 and rib 214 per one rib can be increased by a number of ribs connected. When heat exchange element 206 is carried at the time of maintenance, even if a hand of a person who carries heat exchange element 206 comes into contact with the outer peripheral surface of heat exchange element 206 and an external force is generated, first reinforcing rib 280 functions as a cushion material and distributes the external force to reduce the external force transmitted to heat transfer plate 213 and rib 214. Consequently, it is possible to obtain heat exchange element 206 with high strength in which peeling of rib 214 from heat transfer plate 213 is suppressed in a case where an external force is generated on the outer peripheral surface of heat exchange element 206.

(2) Since the end surface of rib 214 (the distal end portion of rib projection 281) is covered with first reinforcing rib 280, fiber member 240 can be prevented from being exposed to the outer surface of heat exchange element 206. Consequently, for example, when heat exchange element 206 is carried at the time of maintenance, first reinforcing rib 280 can prevent a hand of a person who carries heat exchange element 206 from coming into contact with the outer surface of heat exchange element 206, and the hand from coming into direct contact with fiber member 240 in a case where an external force is generated. As a result, it is possible to obtain the heat exchange element with high strength in which fiber members 240 on the end surface of rib 214 are less likely to be frayed in a case where an external force is generated on the outer surface of heat exchange element 206.

(3) By configuring a heat exchange-type ventilation device using heat exchange element 206 according to the present exemplary embodiment 2-1, it is possible to achieve a heat exchange-type ventilation device in which heat exchange element 206 is less likely to be peeled off in a case where an external force is generated on the outer peripheral surface of heat exchange element 206.

### Exemplary Embodiment 2-2

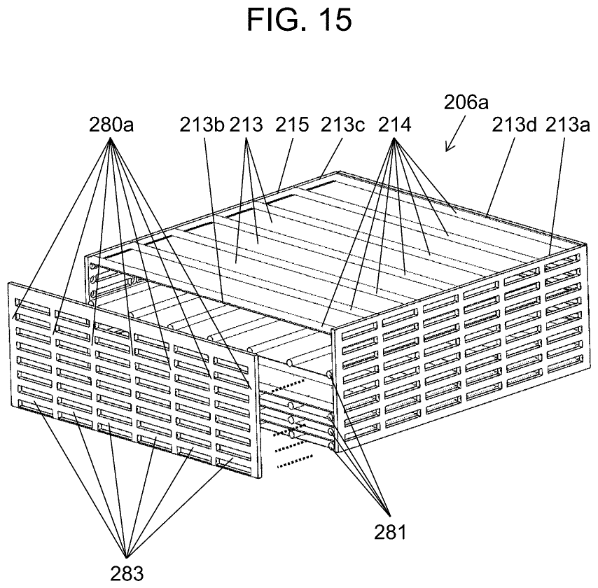

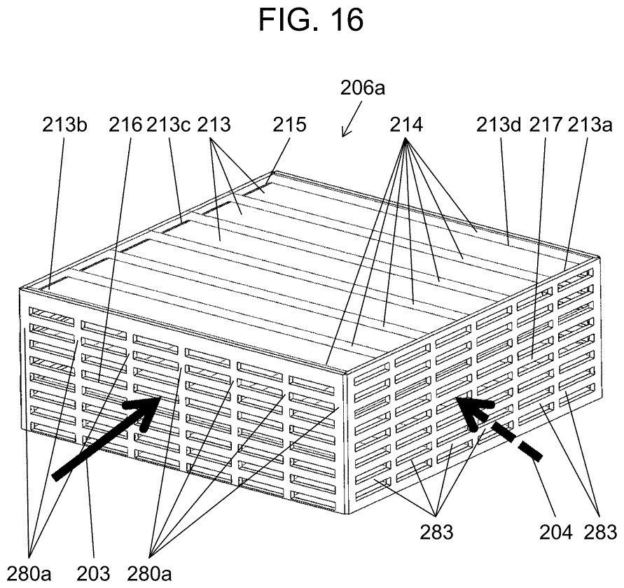

Next, heat exchange element 206a according to an exemplary embodiment 2-2 of the present disclosure will be described with reference to FIGS. 15 and 16. Heat exchange element 206 according to the exemplary embodiment 2-2 has a configuration in which rib projection 281 and first reinforcing rib 280 are combined with each other in the laminating direction of heat exchange element pieces 215. On the other hand, heat exchange element 206a according to the present exemplary embodiment 2-2 is different from the exemplary embodiment 2-1 in that second reinforcing ribs 283 that connect first reinforcing ribs 280a adjacent to each other are provided along ribs 214 located on end sides (end side 213a to end side 213d) of heat transfer plate 213. Other configurations of heat exchange element 206a are similar to those of heat exchange element 206 according to the exemplary embodiment 2-1. Hereinafter, the description of the contents already described in the exemplary embodiment 2-1 will be omitted as appropriate, and differences from the exemplary embodiment 2-1 will be mainly described.

FIG. 15 is an exploded perspective view illustrating a structure of heat exchange element 206a according to the present exemplary embodiment 2-2. FIG. 16 is a perspective view illustrating the structure of heat exchange element 206a.

As illustrated in FIGS. 15 and 16, heat exchange element 206a includes first reinforcing rib 280a that is fitted to rib projection 281 of rib 214. First reinforcing rib 280a corresponds to first reinforcing rib 280 of heat exchange element 206 according to the exemplary embodiment 2-1. Not only first reinforcing rib 280a but also second reinforcing rib 283 that connects first reinforcing ribs 280a adjacent to each other in a ladder shape is formed.

Second reinforcing rib 283 is a reinforcing member for reinforcing first reinforcing rib 280a. In the present exemplary embodiment, second reinforcing ribs 283 are formed integrally with first reinforcing ribs 280. Second reinforcing ribs 283 are formed on the outer peripheral surface of heat exchange element 206 such that second reinforcing ribs 283 do not overlap exhaust air passage 216 and supply air passage 217. Consequently, the longitudinal width of second reinforcing rib 283 is formed to be substantially equal to the height of rib 214 or equal to or less than the height of rib 214. Since the material of second reinforcing rib 283 is the same as the material of first reinforcing rib 280, the description thereof is omitted, but the material of second reinforcing rib 283 may be different from the material of first reinforcing rib 280a.

As described above, according to heat exchange element 206a of the present exemplary embodiment 2-2, the following effects can be obtained.

(4) Second reinforcing rib 283 that connects first reinforcing ribs 280a adjacent to each other is provided along ribs 214 located on the end side of heat transfer plate 213. As a result, the positions of first reinforcing ribs 280a adjacent to each other can be fixed by second reinforcing rib 283, and the positions of heat transfer plate 213 and rib 214 can be further fixed. In addition, as compared with the configuration in which only first reinforcing rib 280a is provided, even in a case where an external force is generated on the outer peripheral surface of heat exchange element 206a, the external force can be distributed, and the external force transmitted to heat transfer plate 213 and rib 214 can be further reduced. Consequently, it is possible to obtain heat exchange element 206a with higher strength in which peeling of rib 214 from heat transfer plate 213 is suppressed in a case where an external force is generated on the outer peripheral surface of heat exchange element 206a.

Note that a number of second reinforcing ribs 283 to be used is equal to the predetermined number of ribs 214 located on the end surface of heat transfer plate 213 at a maximum, but the number of second reinforcing ribs 283 may be reduced in order to secure the minimum strength. Further, to assemble first reinforcing rib 280 and second reinforcing rib 283, for example, a method such as fitting or adhesion can be used, or both first reinforcing rib 280 and second reinforcing rib 283 can be integrated as one component, and the assembling method is not limited at all.

The present disclosure has been described above based on the exemplary embodiments 2-1, 2-2, but the present disclosure is not limited to the exemplary embodiments 2-1, 2-2, and it can be easily assumed that various modifications and variations can be made without departing from the scope of the present disclosure.

In heat exchange element 206 according to the exemplary embodiment 2-1, heat exchange element 206 is configured by fitting rib projection 281 into recess 282 of first reinforcing rib 280, but the present disclosure is not limited thereto. For example, recess 282 of first reinforcing rib 280 and rib projection 281 may be adhered using an adhesive. Alternatively, recess 282 may be a through-hole that penetrates first reinforcing rib 280, and rib projection 281 and first reinforcing rib 280 may be joined by inserting rib projection 281 into the through-hole. As a result, in a case where an external force is generated on the outer surface of heat exchange element 206, the joining force between rib 214 and first reinforcing rib 280 can be further improved, and peeling of rib 214 from heat transfer plate 213 can be suppressed. In particular, in a case where the lengths of the plurality of rib projections 281 are not uniform, it is assumed that the depth of insertion of first reinforcing rib 280 into recess 282 is different. However, when joining of rib projection 281 and first reinforcing rib 280 is enhanced as in the configuration described above, the joint strength between first reinforcing rib 280 and rib 214 can be reliably increased regardless of the length of rib projection 281.

In heat exchange element 206a according to the exemplary embodiment 2-2, at least one of first reinforcing rib 280a and second reinforcing rib 283 may be configured to have higher rigidity than rib 214. With this configuration, for example, when heat exchange element 206 is carried at the time of maintenance, if a hand of a person who carries heat exchange element 206 comes into contact with the outer surface of heat exchange element 206 and an external force is generated, the external force transmitted to rib 214 and heat transfer plate 213 can be reduced. That is, at least one of first reinforcing rib 280a and second reinforcing rib 283 is deformed before the external force is transmitted to each of rib 214 and heat transfer plate 213, so that the external force is absorbed and the external force transmitted to rib 214 and heat transfer plate 213 can be reduced.

In heat exchange element 206a according to the exemplary embodiment 2-2, at least one of first reinforcing rib 280a and second reinforcing rib 283 may be configured to have higher hygroscopicity than rib 214. For example, in a case where air is continuously ventilated in a high-humidity environment accompanied by dew condensation as in summer in Japan, air containing a large amount of moisture flows through exhaust air passage 216 and supply air passage 217. When rib 214 has hygroscopicity, moisture enters the gap in rib 214 by exposing rib 214 to high-humidity air, and rib 214 expands. Alternatively, rib 214 contains moisture to be softened, and the strength decreases. Consequently, at least one of first reinforcing rib 280a and second reinforcing rib 283 has a moisture absorbing action before rib 214 is exposed to high-humidity air, so that it is possible to reduce moisture entering the air passage and to suppress softening of rib 214 due to moisture absorption. Therefore, it is possible to obtain a heat exchange element with high strength in which a decrease in the strength of rib 214 is suppressed.

As means for increasing the hygroscopicity of at least one of first reinforcing rib 280a and second reinforcing rib 283, the following means can be considered. That is, it is useful to make either or both of first reinforcing rib 280a and second reinforcing rib 283 porous, or to apply a coating agent of a water-soluble resin to the surface, but the present disclosure is not limited thereto.

In heat exchange element 206a according to the exemplary embodiment 2-2, in a case where the hygroscopicity of at least one of first reinforcing rib 280a and second reinforcing rib 283 is made higher than that of rib 214, the following configuration may be adopted. That is, only first reinforcing ribs 280a and second reinforcing rib 283 provided on any one of the end sides (end side 213a to end side 213d) of heat transfer plate 213 may be configured to have improved hygroscopicity. For example, in a case of winter in Japan, indoor air has higher temperature and humidity than outdoor air. For this reason, when heat exchange is performed via heat exchange element 206a, the outlet of exhaust air passage 216 (the side of end side 213d of heat transfer plate 213 in FIG. 16) is cooled by the outdoor cold air, and the indoor air with high humidity flows, so that dew condensation is likely to occur. In such a case, the hygroscopicity of at least one of first reinforcing rib 280a and second reinforcing rib 283 provided on the outlet side of exhaust air passage 216 (the side of end side 213d of heat transfer plate 213) is made higher than the hygroscopicity of first reinforcing rib 280a and second reinforcing rib 283 located on the remaining end sides (end side 213a to end side 213c) of heat transfer plate 213. Such a configuration is preferable because dew condensation due to moisture absorption can be reduced.

Regarding the wording used above, heat exchange element 206 of the exemplary embodiment 2-1 and heat exchange element 206a of the exemplary embodiment 2-2 correspond to “heat exchange element” in the claims. Heat transfer plate 213 of the exemplary embodiment 2-1 and the exemplary embodiment 2-2 corresponds to “partition member” in the claims, rib 214 corresponds to “spacing member” in the claims, and heat exchange element piece 215 of the exemplary embodiment 2-1 and the heat exchange element piece according to the exemplary embodiment 2-2 correspond to “unit constituent member” in the claims. Furthermore, exhaust air flow 203 of the exemplary embodiment 2-1 and the exemplary embodiment 2-2 corresponds to “exhaust air flow” in the claims, supply air flow 204 corresponds to “supply air flow” in the claims, exhaust air passage 216 corresponds to “exhaust air passage” in the claims, and supply air passage 217 corresponds to “supply air passage” in the claims. Moreover, first reinforcing rib 280 of the exemplary embodiment 2-1 and first reinforcing rib 280a of the exemplary embodiment 2-2 correspond to “first reinforcing member”, and rib projection 281 of the exemplary embodiment 2-1 and the exemplary embodiment 2-2 corresponds to “projection”. Further, second reinforcing rib 283 of the exemplary embodiment 2-2 corresponds to “second reinforcing member”. Furthermore, heat exchange-type ventilation device 202 of the exemplary embodiment 2-1 and the heat exchange-type ventilation device of the exemplary embodiment 2-2 correspond to “heat exchange-type ventilation device” in the claims.

As described above, the heat exchange element according to the present exemplary embodiment suppresses peeling of the spacing member from the partition member to improve strength, and is useful as a heat exchange element used for a heat exchange-type ventilation device or the like.

### Third Exemplary Embodiment

Conventionally, the following has been known as a structure of a heat exchange element that is used in a heat exchange-type ventilation device in order to secure reliability as a result of an improvement in sealability (a sealing function to prevent air flowing in an air flow path from leaking to the outside) (see, for example, PTL 1).

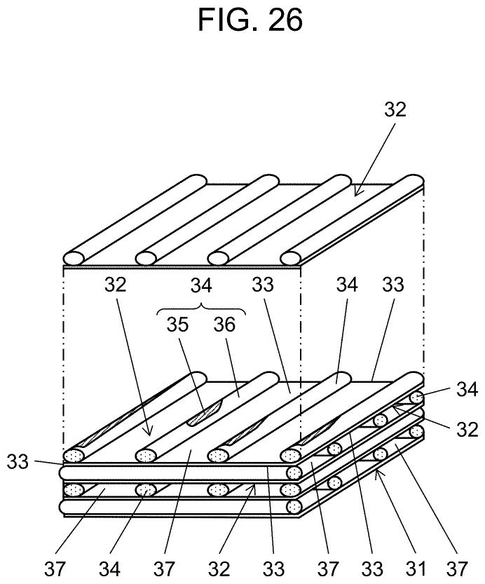

FIG. 26 is an exploded perspective view illustrating a structure of conventional heat exchange element 31.

As illustrated in FIG. 26, heat exchange element 31 is configured by laminating a large number of heat exchange element pieces 32 including functional papers 33 with heat conductivity and ribs 34. On one surface of functional paper 33, a plurality of ribs 34 composed of paper string 35 and hot melt resin 36 that adheres paper string 35 to functional paper 33 are provided in parallel at predetermined intervals. This rib 34 creates a gap between a pair of functional papers 33 laminated adjacent to each other, thereby forming air flow path 37. Heat exchange element 31 is configured such that a plurality of gaps are stacked, and blowing directions of respective air flow paths 37 in adjacent gaps are orthogonal to each other. As a result, in air flow path 37, the supply air flow and the exhaust air flow are alternately ventilated every functional paper 33, and heat is exchanged between the supply air flow and the exhaust air flow.

Such a conventional heat exchange element has a configuration in which a plurality of paper strings with a substantially circular cross-section are adhered with a hot melt resin so as to be tangent to a functional paper (in a state where a circle and a surface are in contact with each other). In such a configuration, since the paper string and the functional paper are adhered only at the tangential portion, the adhesive area is small and the adhesive force is weak. Consequently, in a case where an external force is generated by, for example, accidentally pushing the surface of the heat exchange element with a hand at the time of maintenance or the like, the spacing member such as the paper string described above peels off from the partition member such as the functional paper described above. As a result, the conventional heat exchange element has a problem that the amount of ventilation is insufficient due to leakage of the air flowing in the heat exchange element to the outside of the heat exchange element.

Therefore, an object of the present disclosure is to provide a heat exchange element that suppresses peeling of a spacing member from a partition member on the outer peripheral portion of the heat exchange element in a case where an external force is generated on the outer peripheral surface to suppress a decrease in the amount of ventilation, and a heat exchange-type ventilation device using the heat exchange element.

In order to achieve this object, the heat exchange element according to the present disclosure includes unit constituent members each of which includes a partition member with heat conductivity and a plurality of spacing members provided on one surface of the partition member, the unit constituent members being laminated to alternately form an exhaust air passage and a supply air passage, wherein an exhaust air flow flowing in the exhaust air passage and a supply air flow flowing in the supply air passage exchange heat via the partition member. The spacing member is fixed to the partition member by an adhesive member provided between the spacing member and the partition member. The spacing member includes a first spacing member located on an end side of the partition member and a second spacing member located further inside the partition member than the first spacing member. The partition member is formed on the side surface of the first spacing member so as to cover the side of the outer peripheral side surface of the heat exchange element, so that the desired object is achieved.

According to the present disclosure, it is possible to provide a heat exchange element in which the spacing member is less likely to be peeled off from the partition member in a case where an external force is generated on the outer peripheral surface of the heat exchange element, and a decrease in the amount of ventilation can be suppressed, and a heat exchange-type ventilation device using the heat exchange element.

The heat exchange element according to the present disclosure includes unit constituent members each of which includes a partition member with heat conductivity and a plurality of spacing members provided on one surface of the partition member, the unit constituent members being laminated to alternately form an exhaust air passage and a supply air passage, wherein an exhaust air flow flowing in the exhaust air passage and a supply air flow flowing in the supply air passage exchange heat via the partition member, the spacing member is fixed to the partition member by the adhesive member provided between the spacing member and the partition member, the spacing member includes the first spacing member located on the end side of the partition member and the second spacing member located further inside the partition member than the first spacing member, and the partition member is formed on the side surface of the first spacing member so as to cover the side of the outer peripheral side surface of the heat exchange element.

More specifically, since the partition member covers the side surface of the first spacing member via the adhesive member, the adhesive area between the first spacing member and the partition member increases, and the adhesive strength between the first spacing member and the partition member can be increased. As a result, it is possible to obtain a heat exchange element in which the spacing member is less likely to be peeled off from the partition member on an outer peripheral side in a case where an external force is generated on the outer peripheral surface of the heat exchange element, and a decrease in the amount of ventilation can be suppressed.

Further, the partition member that covers the first spacing member may be fixed to a partition member that constitutes another unit constituent member by the adhesive member. As a result, the adhesive area between the first spacing member and the partition member is further increased, and the adhesive strength between the first spacing member and the partition member can be increased. As a result, it is possible to obtain a heat exchange element in which the partition member (in particular, the first spacing member) is less likely to be peeled off from the spacing member in a case where an external force is generated on the outer peripheral surface of the heat exchange element, and a decrease in the amount of ventilation can be suppressed.

Further, the partition member that covers the first spacing member may be configured to extend to a position between the second spacing member adjacent to the first spacing member and the partition member that constitutes another unit constituent member. As a result, the partition member extended adheres not only to the outer peripheral surface of the first spacing member but also to the outer surface of the second spacing member, so that the adhesive area between the spacing member and the partition member is further increased, and the adhesive strength between the spacing member and the partition member can be increased.

Moreover, the adhesive member preferably has moisture permeability lower than that of the partition member. Consequently, it is possible to suppress the first spacing member located on the end side of the partition member from absorbing water vapor in the air. That is, it is possible to prevent the phenomenon that the first spacing member absorbs moisture and expands to break the adhesive member that fixes the first spacing member to the partition member, resulting in air leakage of the heat exchange element. As a result, it is possible to provide the heat exchange element in which the spacing member is less likely to peel off from the partition member and a decrease in the amount of ventilation can be suppressed.

Further, the heat exchange-type ventilation device according to the present disclosure is configured by mounting the heat exchange element described above therein.

Hereinafter, exemplary embodiments of the present disclosure will be described with reference to the drawings. A third exemplary embodiment includes at least the following exemplary embodiment 3-1 and exemplary embodiment 3-2.

### Exemplary Embodiment 3-1

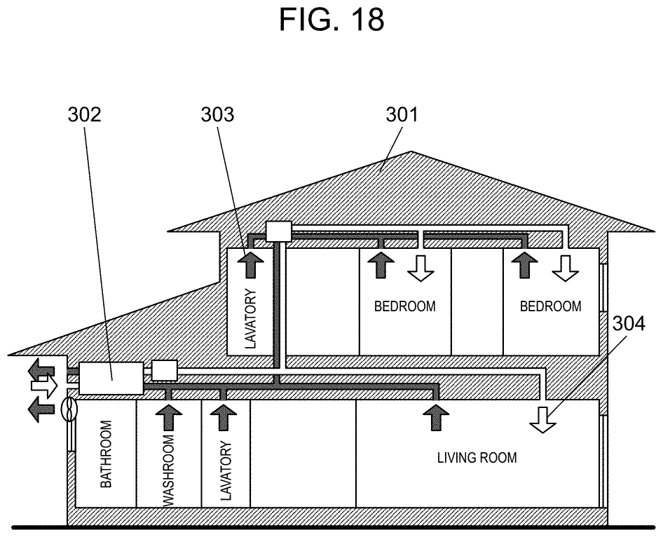

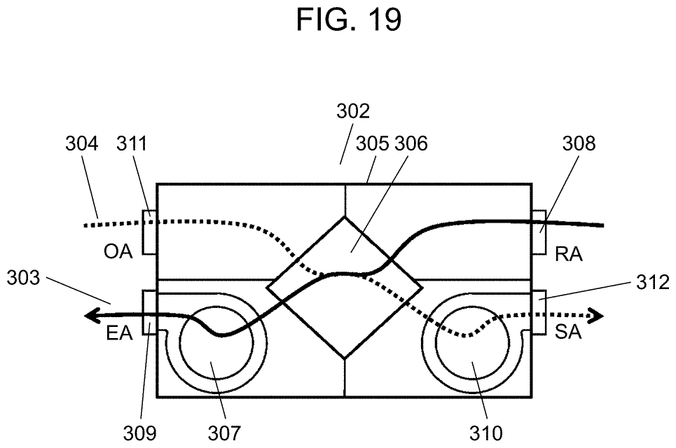

First, an outline of heat exchange-type ventilation device 302 including heat exchange element 306 according to the exemplary embodiment 3-1 of the present disclosure will be described with reference to FIGS. 18 and 19. FIG. 18 is a schematic view illustrating an installation example of heat exchange-type ventilation device 302 including heat exchange element 306. FIG. 19 is a schematic diagram illustrating a structure of heat exchange-type ventilation device 302.

In FIG. 18, heat exchange-type ventilation device 302 is installed inside house 301. Heat exchange-type ventilation device 302 is a device that ventilates indoor air and outdoor air while exchanging heat.

As illustrated in FIG. 18, exhaust air flow 303 is discharged outdoors through heat exchange-type ventilation device 302 as indicated by black arrows. Exhaust air flow 303 is a flow of air exhausted from indoor to outdoor. Supply air flow 304 is introduced into the house through heat exchange-type ventilation device 302 as indicated by white arrows. Supply air flow 304 is a flow of air taken from outdoor to indoor. For example, in winter in Japan, exhaust air flow 303 has a temperature ranging from 20° C. to 25° C., whereas supply air flow 304 reaches below the freezing point in some cases. Heat exchange-type ventilation device 302 performs ventilation, and during ventilation, transfers heat of exhaust air flow 303 to supply air flow 304 to suppress unnecessary release of heat.

As illustrated in FIG. 19, heat exchange-type ventilation device 302 includes body case 305, heat exchange element 306, exhaust fan 307, inside air port 308, exhaust port 309, air supply fan 310, outside air port 311, and air supply port 312. Body case 305 is an outer frame of heat exchange-type ventilation device 302. Inside air port 308, exhaust port 309, outside air port 311, and air supply port 312 are formed on an outer periphery of body case 305. Inside air port 308 is a suction port through which exhaust air flow 303 is sucked into heat exchange-type ventilation device 302. Exhaust port 309 is a discharge port through which exhaust air flow 303 is discharged from heat exchange-type ventilation device 302 to the outdoors. Outside air port 311 is a suction port through which supply air flow 304 is sucked into heat exchange-type ventilation device 302. Air supply port 312 is a discharge port through which supply air flow 304 is discharged from heat exchange-type ventilation device 302 to the indoors.

Heat exchange element 306, exhaust fan 307, and air supply fan 310 are attached to the inside of body case 305. Heat exchange element 306 is a member for exchanging heat between exhaust air flow 303 and supply air flow 304. Exhaust fan 307 is a blower that sucks exhaust air flow 303 from inside air port 308 and discharges exhaust air flow 303 from exhaust port 309. Air supply fan 310 is a blower that sucks supply air flow 304 from outside air port 311 and discharges supply air flow 304 from air supply port 312. By driving exhaust fan 307, exhaust air flow 303 sucked from inside air port 308 passes through heat exchange element 306 and exhaust fan 307, and is discharged from exhaust port 309 to the outdoors. Further, by driving air supply fan 310, supply air flow 304 sucked from outside air port 311 passes through heat exchange element 306 and air supply fan 310, and is supplied from air supply port 312 to the indoors.

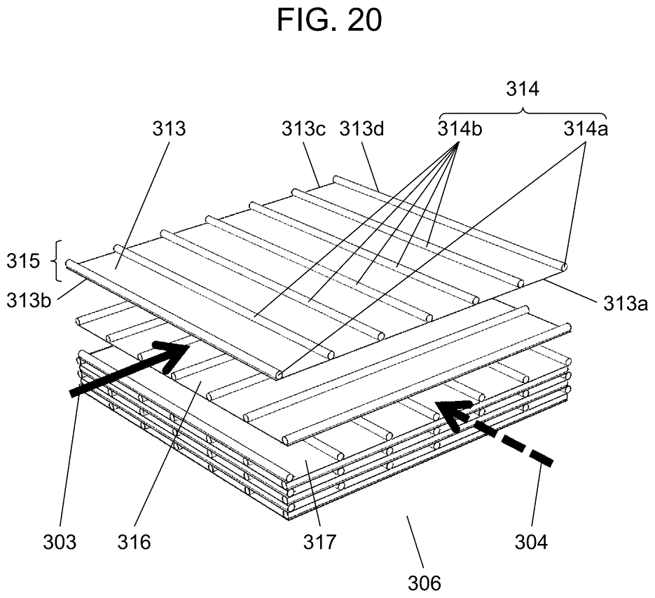

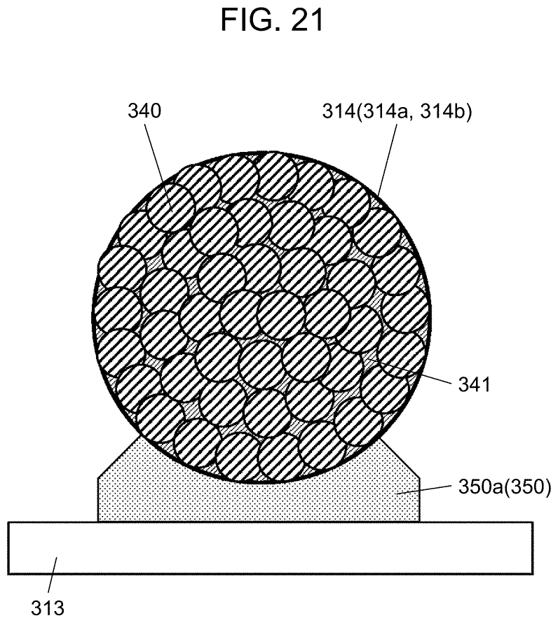

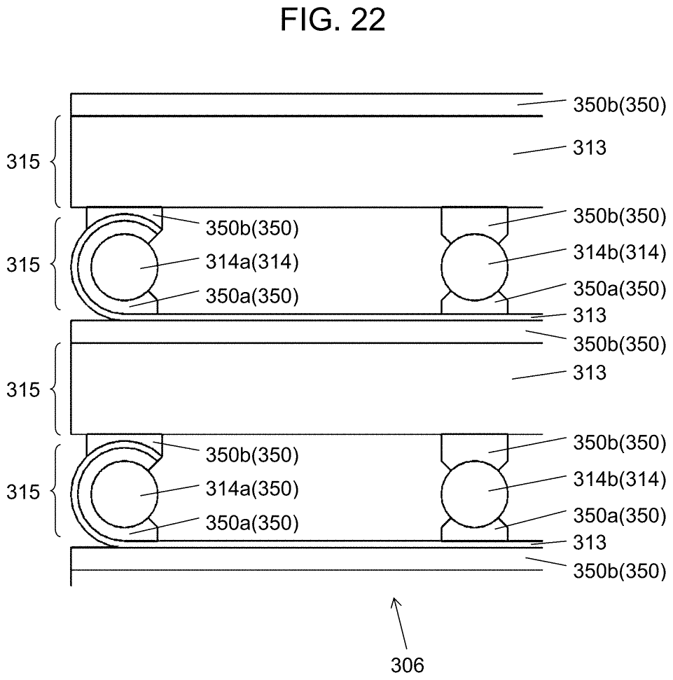

Next, heat exchange element 306 will be described with reference to FIGS. 20 to 22. FIG. 20 is an exploded perspective view illustrating a structure of heat exchange element 306 constituting heat exchange-type ventilation device 302. FIG. 21 is an enlarged cross-sectional view illustrating a structure of rib 314 constituting heat exchange element 306. FIG. 22 is a cross-sectional view illustrating a structure of rib 314 covered with heat transfer plate 313. Note that rib 314 includes outer rib 314a and inner rib 314b, but hereinafter, these ribs are simply referred to as rib 314 unless it is necessary to distinguish these ribs.

As illustrated in FIG. 20, heat exchange element 306 includes a plurality of heat exchange element pieces 315. In each heat exchange element piece 315, a plurality of ribs 314 (outer ribs 314a and inner ribs 314b to be described later) are adhered onto one surface of substantially square heat transfer plate 313. Heat exchange element 306 is formed by laminating the plurality of heat exchange element pieces 315 while alternately changing the direction such that ribs 314 are orthogonal to each other. With such a configuration, exhaust air passage 316 through which exhaust air flow 303 passes and supply air passage 317 through which supply air flow 304 passes are formed, and exhaust air flow 303 and supply air flow 304 alternately flow orthogonally and can exchange heat.

Heat exchange element piece 315 is one unit that constitutes heat exchange element 306. As described above, heat exchange element piece 315 is formed by adhering the plurality of ribs 314 on one surface of substantially square heat transfer plate 313. Rib 314 on heat transfer plate 313 is formed such that the longitudinal direction extends from one end side of heat transfer plate 313 toward the other end side opposing the one end side. Each of the plurality of ribs 314 is linearly formed. Respective ribs 314 are arranged in parallel on the surface of heat transfer plate 313 at predetermined intervals. Specifically, as illustrated in FIG. 20, on one surface of heat transfer plate 313 constituting one of two vertically adjacent heat exchange element pieces 315, ribs 314 are adhered such that the longitudinal direction of rib 314 extends from end side 313a of heat transfer plate 313 toward end side 313c opposing end side 313a. Further, on one surface of heat transfer plate 313 constituting another heat exchange element piece 315, ribs 314 are adhered such that the longitudinal direction of rib 314 extends from end side 313b (perpendicular to end side 313a) of heat transfer plate 313 toward end side 313d opposing end side 313b. Furthermore, in heat exchange element piece 315, heat transfer plate 313 is formed so as to cover rib 314 on the side of the outer peripheral side surface of heat exchange element 306 (heat exchange element piece 315), rib 314 being located at the outermost periphery among the plurality of ribs 314 (rib 314 located at the end side of heat transfer plate 313: outer rib 314a to be described later). Rib 314 will be described later.

Heat transfer plate 313 is a plate-like member for exchanging heat when exhaust air flow 303 and supply air flow 304 flow with heat transfer plate 313 being interposed therebetween. Heat transfer plate 313 is formed of a heat transfer paper based on cellulose fiber, and has heat conductivity, moisture permeability, and hygroscopicity. However, the material of heat transfer plate 313 is not limited thereto. As heat transfer plate 313, for example, a moisture-permeable resin film based on polyurethane or polyethylene terephthalate, a paper material based on cellulose fiber, ceramic fiber, or glass fiber, or the like can be used. As heat transfer plate 313, a thin sheet that has heat conductivity and does not allow air to permeate can be used.

The plurality of ribs 314 are provided between a pair of opposing sides of heat transfer plate 313, and are formed from one end side toward the other end side. Rib 314 is a substantially columnar member for forming a gap in which exhaust air flow 303 or supply air flow 304 passes between heat transfer plates 313 when heat transfer plates 313 are laminated, that is, exhaust air passage 316 or supply air passage 317.

As illustrated in FIG. 21, each of the plurality of ribs 314 has a substantially circular cross-section. The member that has a substantially flat shape, a rectangular shape, a hexagonal shape, or the like as the cross-sectional shape of rib 314 in addition to the substantially circular shape may be used. Rib 314 is composed of a plurality of fiber members 340, and is fixed to heat transfer plate 313 via adhesive 350 (bonding adhesive 350a, laminate adhesive 350b to be described later with reference to FIG. 22). Further, rib 314 is formed by impregnating fine voids between fiber members 340 with adhesive 341.

As illustrated in FIG. 21, each of fiber members 340 is a fiber member that has a substantially circular cross-section and extends in the same direction as rib 314. As a material of fiber member 340, any material that has hygroscopicity and also has a certain strength can be used, and a resin member such as polypropylene, polyethylene, polyethylene terephthalate, or polyamide, a paper material based on cellulose fiber, ceramic fiber, or glass fiber, cotton, silk, or hemp can be used.

As adhesive 350 (or adhesive 341), a chemical agent that exerts an adhesive force on rib 314 is preferable, and for example, in a case where a paper string is used for rib 314, a vinyl acetate resin-based adhesive that has good adhesiveness to a hydrophilic paper can be used. In addition, curing methods such as moisture curing, pressure curing, and ultraviolet (UV) curing can be selected according to a manufacturing method. However, the present disclosure is not limited to these chemical agents, and known adhesives and adhesion methods can be used depending on the material of rib 314, and there is no difference in effect.

As illustrated in FIG. 20, the plurality of ribs 314 includes outer rib 314a arranged along the outer edge (the end side) of heat transfer plate 313 and a plurality of inner ribs 314b disposed between outer ribs 314a at both ends. Outer rib 314a is a rib that is formed along end side 313b or end side 313d on the outer edge of heat transfer plate 313, which is the outermost peripheral position of rib 314, among the plurality of ribs 314. Inner rib 314b is a rib formed in a region sandwiched between outer ribs 314a at both ends among the plurality of ribs 314.

In heat exchange element 306 according to the present exemplary embodiment, as illustrated in FIG. 22, heat transfer plate 313 is formed on outer rib 314a so as to cover the outer surface of outer rib 314a (the outer peripheral side surface of heat exchange element 306). At this time, outer rib 314a and heat transfer plate 313 are fixed by bonding adhesive 350a. In addition, heat transfer plate 313 covering outer rib 314a is formed to extend to a position between the upper surface of outer rib 314a and heat transfer plate 313 constituting another heat exchange element piece 315. Heat transfer plate 313 covering outer rib 314a is then fixed to heat transfer plate 313 constituting another heat exchange element piece 315 by laminate adhesive 350b.

On the other hand, as illustrated in FIG. 22, inner rib 314b is fixed to heat transfer plate 313 by bonding adhesive 350a, and is also fixed to heat transfer plate 313 constituting another heat exchange element piece 315 by laminate adhesive 350b. Here, the thickness of laminate adhesive 350b formed on the upper surface of inner rib 314b is formed to be thicker than the thickness of laminate adhesive 350b formed on the upper surface of outer rib 314a. That is, laminate adhesive 350b formed on the upper surface of inner rib 314b is formed to have a thickness equal to the total thickness of laminate adhesive 350b, heat transfer plate 313, and bonding adhesive 350a formed on the upper surface of outer rib 314a. As a result, the height on the outer peripheral side of heat exchange element piece 315 (corresponding to the height of the air passage) is adjusted to be equal to the height on the inner side.

Heat exchange element 306 according to the present exemplary embodiment is configured by alternately laminating heat exchange element pieces 315 having the plurality of ribs 314 (outer ribs 314a, inner ribs 314b).

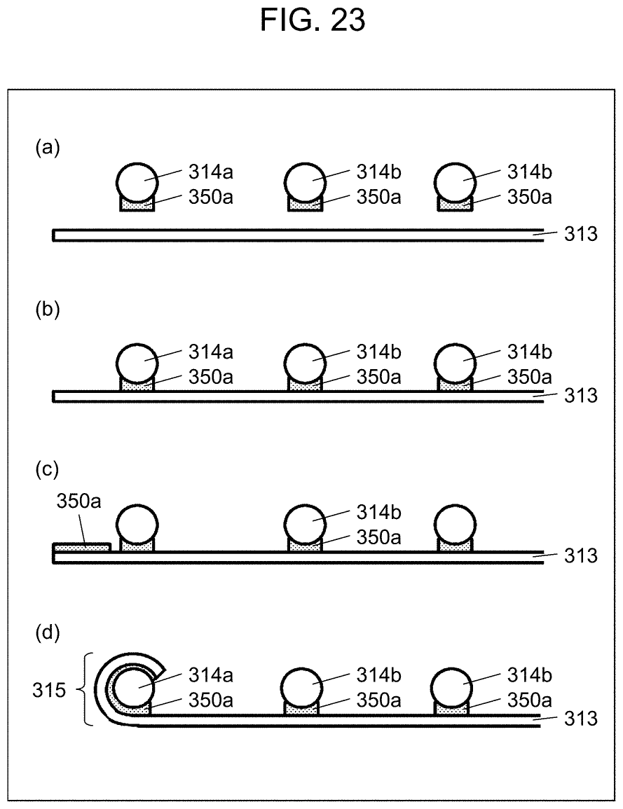

Next, a method of manufacturing outer rib 314a covered with heat transfer plate 313 will be described with reference to FIG. 23. FIG. 23 is a view for explaining a method of manufacturing rib 314 covered with heat transfer plate 313. Here, parts (a) to (d) of FIG. 23 illustrate steps of manufacturing rib 314 covered with heat transfer plate 313 in a manufacturing process of heat exchange element 306. That is, part (a) of FIG. 23 illustrates a first step of applying bonding adhesive 350a to both outer rib 314a and inner rib 314b. Part (b) of FIG. 23 illustrates a second step of adhering both outer rib 314a and inner rib 314b to which bonding adhesive 350a is applied to heat transfer plate 313. Part (c) of FIG. 23 illustrates a third step of applying bonding adhesive 350a to a part of heat transfer plate 313 on which no rib 314 adjacent to outer rib 314a is present. Part (d) of FIG. 23 illustrates a fourth step of adhering heat transfer plate 313 on which no rib 314 adjacent to outer rib 314a is present along the outer surface of outer rib 314a (the outer peripheral side surface of heat exchange element 306).

First, as the first step, as illustrated in part (a) of FIG. 23, ribs 314 (outer rib 314a, inner rib 314b) with a substantially circular cross-section are arranged at predetermined intervals, and the position of heat transfer plate 313 is adjusted such that heat transfer plate 313 is present outside outer rib 314a. Bonding adhesive 350a is then applied to the surface of each rib 314 in contact with heat transfer plate 313.

Next, as the second step, as illustrated in part (b) of FIG. 23, each rib 314 having bonding adhesive 350a applied thereto is adhered to heat transfer plate 313.

Next, as the third step, as illustrated in part (c) of FIG. 23, bonding adhesive 350a is applied onto heat transfer plate 313 located on the outer side (the side of the outer peripheral side surface) of outer rib 314a.

Finally, as the fourth step, as illustrated in part (d) of FIG. 23, heat transfer plate 313 located on the outer side (the side of the outer peripheral side surface) of outer rib 314a is wound and adhered along the surface of outer rib 314a.

In this way, outer rib 314a covered with heat transfer plate 313 is manufactured. As a result, heat exchange element piece 315 in which the plurality of ribs 314 (outer rib 314a, inner rib 314b) are fixed on heat transfer plate 313 is formed.

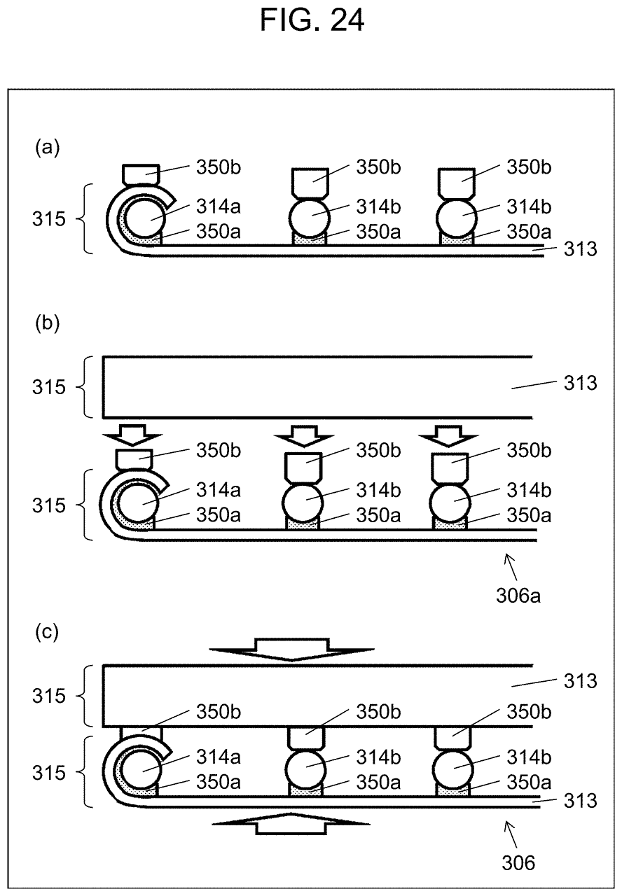

Next, a method of manufacturing heat exchange element 306 according to the present exemplary embodiment 3-1 will be described with reference to FIG. 24. FIG. 24 is a view for explaining the method of manufacturing heat exchange element 306. Here, parts (a) to (c) of FIG. 24 illustrate steps of manufacturing heat exchange element 106 performed following the steps of manufacturing rib 314 covered with heat transfer plate 313. That is, part (a) of FIG. 24 illustrates a fifth step of applying laminate adhesive 350b onto rib 314. Part (b) of FIG. 24 illustrates a sixth step of laminating heat exchange element piece 315 to form laminate 306a. Part (c) of FIG. 24 illustrates a seventh step of compressing laminate 306a in a laminating direction to form heat exchange element 306.

First, as a fifth step, as illustrated in part (a) of FIG. 24, laminate adhesive 350b is applied onto both inner rib 314b and heat transfer plate 313 covering outer rib 314a. At this time, the thickness of laminate adhesive 350b formed on the upper surface of inner rib 314b is set to be thicker than the thickness of laminate adhesive 350b formed on the upper surface of outer rib 314a.

Next, as the sixth step, as illustrated in part (b) of FIG. 24, a plurality of heat exchange element pieces 315 are laminated while alternately changing the direction vertically such that ribs 314 are orthogonal to each other, so that laminate 306a, which is a precursor of heat exchange element 306, is formed. Note that inner rib 314b and heat transfer plate 313 covering outer rib 314a, which are illustrated in part (b) of FIG. 24, and heat transfer plate 313 of overlying heat exchange element piece 315 are adhered by laminate adhesive 350b applied in the fifth step.

Finally, as the seventh step, as illustrated in part (c) of FIG. 24, laminate 306a is compressed from the laminating direction (vertical direction) of heat exchange element pieces 315 to form heat exchange element 306 in which air passages (exhaust air passage 316, supply air passage 317) with a predetermined space (a space corresponding to the sum of the height of rib 314 and the thickness of adhesive 350) in the laminating direction is formed. Note that adhesive 350 is a generic term for bonding adhesive 350a and laminate adhesive 350b. At this time, the amount of application of laminate adhesive 350b is adjusted such that predetermined spaces of the air passages (exhaust air passage 316, supply air passage 317) become uniform.

In this way, heat exchange element 306 that has not only inner rib 314b but also outer rib 314a covered with heat transfer plate 313 is manufactured.

As described above, according to heat exchange element 306 of the present exemplary embodiment 3-1, the following effects can be obtained.

(1) Heat transfer plate 313 covers the side surface of outer rib 314a (the outer peripheral side surface of heat exchange element 306) via adhesive 350 (bonding adhesive 350a). For this reason, the adhesive area between outer rib 314a and heat transfer plate 313 increases, and the adhesive strength between outer rib 314a and heat transfer plate 313 can be increased. Consequently, even in a case where an external force is generated by, for example, accidentally pushing the surface of heat exchange element 306 with a hand at the time of maintenance or the like, heat transfer plate 313 is less likely to be peeled off from rib 314 on the outer peripheral side. As a result, it is possible to suppress the air flowing in heat exchange element 306 from leaking to the outside of heat exchange element 306. That is, it is possible to obtain heat exchange element 306 capable of suppressing a decrease in the amount of ventilation as compared with a heat exchange element in which heat transfer plate 313 does not cover outer rib 314a.

(2) In heat exchange element 306, heat transfer plate 313 covering outer rib 314a is fixed to heat transfer plate 313 constituting another heat exchange element piece 315 by adhesive 350 (laminate adhesive 350b). Consequently, the adhesive area between outer rib 314a and heat transfer plate 313 further increases, and the adhesive strength between outer rib 314a and heat transfer plate 313 can be increased. As a result, it is possible to obtain heat exchange element 306 in which heat transfer plate 313 is less likely to be peeled off from rib 314 (in particular, outer rib 314a) in a case where an external force is generated on the outer peripheral surface of heat exchange element 306, and a decrease in the amount of ventilation can be suppressed.

(3) In heat exchange element 306, heat transfer plate 313 covering outer rib 314a is adhered to heat transfer plate 313 constituting another heat exchange element piece 315 by laminate adhesive 350b. Accordingly, in a case where rib 314 and heat transfer plate 313 are made of different materials, it is possible to prevent a decrease in adhesive strength due to a difference in the property of each material. That is, by adhering heat transfer plates 313 made of the same material to each other, the adhesive strength can be increased. As a result, it is possible to obtain heat exchange element 306 in which heat transfer plate 313 is less likely to be peeled off from rib 314 on the outer peripheral side in a case where an external force is generated on the outer peripheral surface of heat exchange element 306, and the amount of ventilation can be maintained.

(4) Adhesive 350 (in particular, bonding adhesive 350a) is configured to have lower moisture permeability than heat transfer plate 313. Consequently, it is possible to suppress outer rib 314a located on the end side of heat transfer plate 313 from absorbing moisture (water vapor) in the air. That is, it is possible to prevent the phenomenon that outer rib 314a absorbs moisture and expands to break adhesive 350 that fixes outer rib 314a to heat transfer plate 313, resulting in air leakage of heat exchange element 306. As a result, it is possible to provide heat exchange element 306 in which rib 314 is less likely to peel off from heat transfer plate 313 and a decrease in the amount of ventilation can be suppressed.

As adhesive 350 with low hygroscopicity, for example, an adhesive containing no hydrophilic group (for example, a hydroxy group or the like) in a monomer based on a solution-based adhesive (phenol resin or the like) or a solvent-free adhesive (epoxy resin or the like) cured by a chemical reaction can be used.

(5) By configuring a heat exchange-type ventilation device using heat exchange element 306 according to the present exemplary embodiment 3-1, it is possible to achieve a heat exchange-type ventilation device in which heat exchange element 306 is less likely to be peeled off in a case where an external force is generated on the outer peripheral surface of heat exchange element 306, and a decrease in the amount of ventilation can be suppressed.

### Exemplary Embodiment 3-2

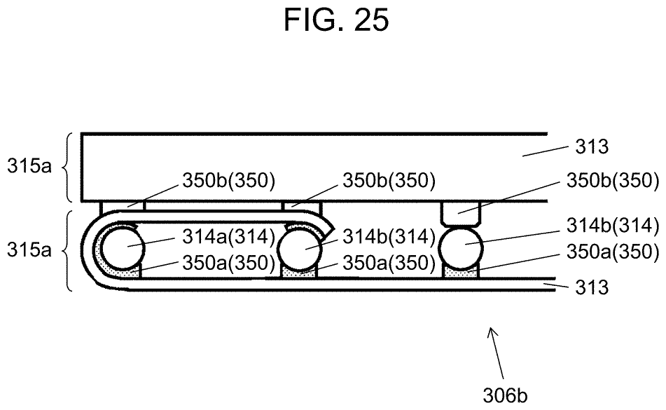

Next, heat exchange element 306b according to an exemplary embodiment 3-2 of the present disclosure will be described with reference to FIG. 25. Heat exchange element 306 according to the exemplary embodiment 3-1 has a configuration in which heat exchange element pieces 315 in which only outer rib 314a is covered with heat transfer plate 313 are laminated. On the other hand, in heat exchange element 306b according to the present exemplary embodiment 3-2, heat transfer plate 313 covering outer rib 314a is extended to a position between inner rib 314b adjacent to outer rib 314a and heat transfer plate 313 constituting another heat exchange element piece 315. Other configurations of heat exchange element 306b are similar to those of heat exchange element 306 according to the exemplary embodiment 3-1. Hereinafter, the description of the contents already described in the exemplary embodiment 3-1 will be omitted as appropriate, and differences from the exemplary embodiment 3-1 will be mainly described.

FIG. 25 is a cross-sectional view of heat exchange element 306b according to the exemplary embodiment 3-2 of the present disclosure. As illustrated in FIG. 25, heat exchange element piece 315a according to the present exemplary embodiment 3-2 has a configuration in which heat transfer plate 313 covering outer rib 314a is extended to a position between inner rib 314b adjacent to outer rib 314a and heat transfer plate 313 constituting another heat exchange element piece 315a.

Heat exchange element 306b is formed by laminating the plurality of heat exchange element pieces 315a while alternately changing the direction vertically such that ribs 314 are orthogonal to each other.

As described above, according to heat exchange element 306b of the present exemplary embodiment 3-2, the following effects can be obtained.

(6) In heat exchange element 306b, heat transfer plate 313 covering outer rib 314a is configured to be extended to a position between inner rib 314b adjacent to outer rib 314a and heat transfer plate 313 constituting another heat exchange element piece 315a. As a result, heat transfer plate 313 extended adheres not only to the outer peripheral surface of outer rib 314a but also to the outer surface of adjacent inner rib 314b. For this reason, the adhesive area between rib 314 on the outer peripheral side and heat transfer plate 313 further increases, and the adhesive strength between rib 314 and heat transfer plate 313 can be increased. Consequently, it is possible to obtain heat exchange element 306b in which heat transfer plate 313 is less likely to be peeled off from rib 314 (in particular, outer rib 314a and inner rib 314b adjacent to outer rib 314a) in a case where an external force is generated on the outer peripheral surface of heat exchange element 306b, and a decrease in the amount of ventilation can be suppressed.

The present disclosure has been described above based on the exemplary embodiments 3-1, 3-2. It will be understood by those skilled in the art that these exemplary embodiments 3-1, 3-2 are merely examples, modifications in which components or processes of these exemplary embodiments are variously combined are possible, and these modifications still fall within the scope of the present disclosure.

In heat exchange element 306 according to the present exemplary embodiment 3-1, heat transfer plate 313 covering outer rib 314a is extended to a position between the upper surface of outer rib 314a and heat transfer plate 313 constituting another heat exchange element piece 315, but the present disclosure is not limited thereto. For example, heat transfer plate 313 covering outer rib 314a may be formed so as to cover a part of the outer surface of outer rib 314a (the side of the outer peripheral side surface of heat exchange element 306). Also in this case, the adhesive strength can be increased in the covered portion.

Regarding the wording used above, heat exchange element 306 of the exemplary embodiment 3-1 and heat exchange element 306b of the exemplary embodiment 3-2 correspond to “heat exchange element”. In addition, heat transfer plate 313 of the exemplary embodiment 3-1 and the exemplary embodiment 3-2 corresponds to “partition member”, rib 314 corresponds to “spacing member”, outer rib 314a corresponds to “first spacing member”, and inner rib 314b corresponds to “second spacing member”. Further, heat exchange element piece 315 of the exemplary embodiment 3-1 and heat exchange element piece 315a of the exemplary embodiment 3-2 correspond to “unit constituent member”, and adhesive 350 (bonding adhesive 350a, laminate adhesive 350b) of the exemplary embodiments 3-1 and 3-2 corresponds to “adhesive member”. Furthermore, heat exchange-type ventilation device 302 of the exemplary embodiment 3-1 and the heat exchange-type ventilation device of the exemplary embodiment 3-2 correspond to “heat exchange-type ventilation device”. Moreover, exhaust air flow 303 of the exemplary embodiment 3-1 and the exemplary embodiment 3-2 corresponds to “exhaust air flow”, supply air flow 304 corresponds to “supply air flow”, exhaust air passage 316 corresponds to “exhaust air passage”, and supply air passage corresponds to “supply air passage”.

As described above, the heat exchange element according to the exemplary embodiment 3-1 and the exemplary embodiment 3-2 is useful as a heat exchange element used for a heat exchange-type ventilation device, in which the spacing member is less likely to be peeled off from the partition member and the amount of ventilation can be maintained.

### INDUSTRIAL APPLICABILITY

As described above, the heat exchange element according to the present disclosure can suppress closing of an air passage caused by a dimensional change of a rib due to an external force or the like and maintain high heat exchange efficiency, and is useful as a heat exchange element used for a heat exchange-type ventilation device or the like.

### REFERENCE MARKS IN THE DRAWINGS

101: house
102: heat exchange-type ventilation device
103: exhaust air flow
104: supply air flow
105: body case
106: heat exchange element
106a: laminate
107: exhaust fan
108: inside air port
109: exhaust port
110: air supply fan
111: outside air port
112: air supply port
113: heat transfer plate
113a: end side
113b: end side
113c: end side
113d: end side
114: rib
114a: plane
114b: side surface
115: heat exchange element piece
116: exhaust air passage
117: supply air passage
120: rib
140: fiber member
141: adhesive member
142: fiber melting layer
142a: fiber melting layer
170: heat press machine
201: house
202: heat exchange-type ventilation device
203: exhaust air flow
204: supply air flow
205: body case
206: heat exchange element
206a: heat exchange element
207: exhaust fan
208: inside air port
209: exhaust port
210: air supply fan
211: outside air port
212: air supply port
213: heat transfer plate
213a: end side
213b: end side
213c: end side
213d: end side
214: rib
215: heat exchange element piece
216: exhaust air passage
217: supply air passage
240: fiber member
241: adhesive
280: first reinforcing rib
280a: first reinforcing rib
281: rib projection
282: recess
283: second reinforcing rib
301: house
302: heat exchange-type ventilation device
303: exhaust air flow
304: supply air flow
305: body case
306: heat exchange element
306a: laminate
306b: heat exchange element
307: exhaust fan
308: inside air port
309: exhaust port
310: air supply fan
311: outside air port
312: air supply port
313: heat transfer plate
313a: end side
313b: end side
313c: end side
313d: end side
314: rib
314a: outer rib
314b: inner rib
315: heat exchange element piece
315a: heat exchange element piece
316: exhaust air passage
317: supply air passage
340: fiber member
341: adhesive
350: adhesive
350a: bonding adhesive
350b: laminate adhesive
11: heat exchange element
12: heat exchange element piece
13: functional paper
14: rib
15: paper string
16: hot melt resin
17: air flow path
21: heat exchange element
22: heat exchange element unit
23: functional paper
24: rib
25: paper string
26: hot melt resin
27: air flow path
31: heat exchange element
32: heat exchange element piece
33: functional paper
34: rib
35: paper string
36: hot melt resin
37: air flow path

1. A heat exchange element comprising:
unit constituent members each of which includes a partition member with heat conductivity and a plurality of spacing members provided on one surface of the partition member, the unit constituent members being laminated to alternately form an exhaust air passage and a supply air passage, wherein
an exhaust air flow flowing in the exhaust air passage and a supply air flow flowing in the supply air passage exchange heat via the partition member,
the partition member and each of the plurality of spacing members are fixed to each other by an adhesive member,
the each of the plurality of spacing members includes a plurality of fiber members with heat meltability and hygroscopicity, and
the each of the plurality of spacing members has a fiber melting layer formed by melting and fixing the plurality of fiber members on a surface of the each of the plurality of spacing members.

2. The heat exchange element according to claim 1, wherein the each of the plurality of spacing members has the fiber melting layer with a planar shape on an adhesive surface with the partition member.

3. The heat exchange element according to claim 1, wherein the plurality of fiber members are exposed on a side surface of the each of the plurality of spacing members.

4. The heat exchange element according to claim 1, wherein the each of the plurality of spacing members is formed by twisting the plurality of fiber members.

5. A heat exchange-type ventilation device comprising the heat exchange element according to claim 1.
